(19) United States
(12) Patent Application Publication
(10) Pub. No.: US 2025/0292134 A1
(43) Pub. Date: Sep. 18, 2025

(54) Quantum State Transfer between Nodes in Computing Network

(71) Applicant: Rigetti & Co, LLC, Berkeley, CA (US)

(72) Inventors: Eyob A. Sete, Walnut Creek, CA (US); Brandon William Langley, Oakland, CA (US); Stefano Poletto, Orinda, CA (US); Beatriz Yankelevich, Cambridge, MA (US)

(73) Assignee: Rigetti & Co, LLC, Berkeley, CA (US)

(21) Appl. No.: 19/224,260

(22) Filed: May 30, 2025

Related U.S. Application Data
(63) Continuation of application No. PCT/US2023/081885, filed on Nov. 30, 2023.
(60) Provisional application No. 63/385,864, filed on Dec. 2, 2022.

(51) Int. Cl. G06N 10/40

(52) U.S. Cl. CPC G06N 10/40

(57) ABSTRACT

In a general aspect, a quantum state transferring process is performed in a computing network. In some implementations, a method of transferring a quantum state between nodes in a computing network includes receiving a signal at a first node transmitted on a transmission line from a second node. The first node includes a superconducting quantum processing circuit including a tunable-frequency coupler device with a superconducting circuit loop and a first resonator device having a tunable linewidth. The first resonator device is capacitively coupled to the tunable-frequency coupler coupled to the transmission line. The second node includes a second resonator device having a fixed linewidth coupled to the transmission line. The method includes modifying the tunable linewidth of the first resonator device over time while the signal transfers a quantum state to the first resonator device from the second resonator device, by varying a magnetic flux pulse applied to the superconducting circuit loop.

### CROSS-REFERENCE TO RELATED APPLICATIONS

This application claims priority to U.S. Provisional Patent Application No. 63/385,864, filed Dec. 2, 2022, entitled “Quantum State Transfer between Nodes in Computing Network.” The above-referenced priority document is incorporated herein by reference in its entirety.

### GOVERNMENT SUPPORT

This invention was made with government support under Contract No. FA864921P0781 awarded by the Air Force Research Laboratory. The government has certain rights in the invention.

### TECHNICAL FIELD

The following description relates to quantum state transfer between nodes in a computing network.

### BACKGROUND

Quantum computers can perform computational tasks by storing and processing information within quantum states of quantum systems. For example, qubits (i.e., quantum bits) can be stored in, and represented by, an effective two-level sub-manifold of a quantum coherent physical system. A variety of physical systems have been proposed for quantum computing applications. Examples include superconducting circuits, trapped ions, spin systems, and others.

### BRIEF DESCRIPTION OF THE DRAWINGS

FIG. 1 is a block diagram of an example computing environment.

FIG. 2 is a block diagram showing aspects of an example computing network.

FIG. 3A is a block diagram showing aspects of an example computing network.

FIG. 3B is a plot showing time profiles of the linewidths of the first and second resonator devices during a time period (0≤t≤t_{f}) when a quantum state is transferred from the first resonator device to the second resonator device in FIG. 3A.

FIG. 4 is a plot showing a transfer efficiency η in % as a function of transfer protocol time t_{f} in nanosecond (ns).

FIG. 5A is a block diagram showing aspects of an example computing network.

FIG. 5B is a plot showing time profiles of the linewidths of the first and second resonator devices during a time period (0≤t≤t_{f}) when a quantum state is transferred from the first resonator device to the second resonator device in FIG. 5A.

FIG. 6 is a circuit diagram showing an example equivalent circuit of a portion of a superconducting quantum processing circuit of a node in a computing network.

FIG. 7 is a flow chart showing aspects of an example process.

FIG. 8A includes a plot showing a coupling in MHz and a plot showing the transition frequency of the tunable-frequency coupler device in the first node as a function of the magnetic flux pulse in flux quantum (ϕ₀) applied on the superconducting circuit loop of the tunable-frequency coupler device.

FIG. 8B is a plot showing the effective linewidth in MHz of the resonator device of the first node as a function of the magnetic flux pulse in flux quantum (Φ₀) applied on the tunable-frequency coupler device at different frequency offsets.

FIG. 8C is a plot showing the effective linewidth in MHz of the resonator device of the first node as a function of the transition frequency in GHz of the tunable-frequency coupler device at different frequency offsets.

FIG. 8D is a plot showing the effective linewidth in MHz of the resonator device of the first node as a function of time in ns.

FIGS. 9A-9C are circuit diagrams showing example equivalent circuits of a portion of an example quantum processing circuit of a node in a computing network.

FIG. 10 is a circuit diagram showing an example equivalent circuit of a portion of an example quantum processing circuit of a node in a computing network.

FIG. 11 is a circuit diagram showing aspects of an equivalent circuit of a superconducting quantum processing circuit of a node in a computing network.

FIG. 12 is a plot showing distribution of microwave flux along an example Purcell filter in a superconducting quantum processing circuit of a node in a computing network at different boundary conditions.

### DETAILED DESCRIPTION

In some aspects of what is described here, quantum states are transferred between nodes in a computing network. The nodes are communicably coupled by a transmission line. In some implementations, a first node either receiving a quantum state from a second node or transmitting a quantum state to a second node includes a superconducting quantum processing circuit. The superconducting quantum processing circuit includes a tunable-frequency coupler device with a superconducting circuit loop and a first resonator device capacitively coupled to the tunable-frequency coupler device. The second node includes a second resonator device. A quantum state can be carried by a signal transmitted on the transmission line between the first and the second node during a time period. During the time period when the signal carrying a quantum state is transferred, a tunable linewidth of the first resonator device is modified; and a linewidth of the second resonator device is fixed at a constant value. In some implementations, the tunable linewidth of the first resonator device is modified by varying a magnetic flux pulse applied to the superconducting circuit loop of the tunable-frequency coupler device. Pulse parameters of the magnetic flux pulse are selected and tuned to maximize the quantum state transfer efficiency between the first and second resonator devices of the nodes.

Effective state transfer is one of the most important problems in quantum information processing. In some implementations, the systems and techniques described here can provide technical advantages and improvements. For example, the systems and methods presented here provide an effective control of the back reflection from the receiving node and provide a high-efficiency and high-fidelity transfer of quantum state. The systems and methods presented here can enable direct and long-distance quantum state transfer (e.g., quantum teleportation) between two remote quantum nodes in a quantum network. In some cases, a combination of these and potentially other advantages and improvements may be obtained.

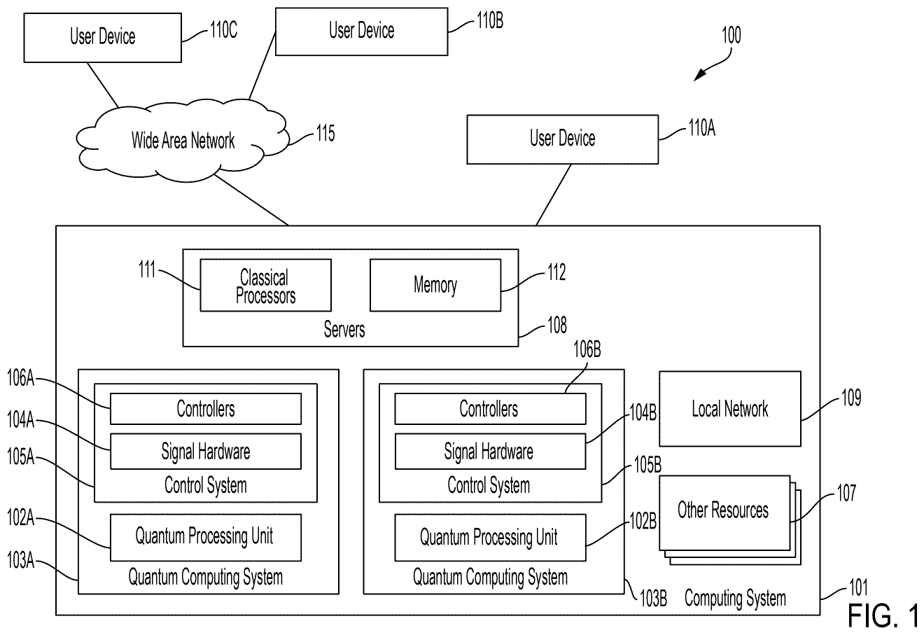

FIG. 1 is a block diagram of an example computing environment 100. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109, or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B, and the other resources 107 may communicate with each other through the local network 109. In some implementations, the local network 109 operates as a communication channel that provides one or more low-latency communication pathways from the server 108 to the quantum computing systems 103A, 103B (or to one or more of the elements of the quantum computing systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remotely from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B, and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115, and possibly other channels. In some implementations, the servers 108 may include a host server, an application server, a virtual server, or a combination of these and other types of servers. The servers 108 may include additional or different features and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media, and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution. For example, the servers 108 may send programs to the quantum computing system 103A, the quantum computing system 103B, or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv:1608.03355v2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may be expressed in another form or format. In some cases, a program may utilize Quil-T, described in the publication “Gain deeper control of Rigetti quantum processing units with Quil-T,” available at https://medium.com/rigetti/gain-deeper-control-of-rigetti-quantum-processors-with-quil-t-ea8945061e5b dated Dec. 10, 2020, which is hereby incorporated by reference in the present disclosure.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

In some implementations, the servers 108 generate a schedule for executing programs, allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing environment operates as a cloud-based quantum computing (QC) environment, and the servers 108 operate as a host system for the cloud-based QC environment. The cloud-based QC environment may include software elements that operate on both the user devices 110 and the computer system 101 and interact with each other over the wide area network 115. For example, the cloud-based QC environment may provide a remote user interface, for example, through a browser or another type of application on the user devices 110. The remote user interface may include, for example, a graphical user interface or another type of user interface that obtains input provided by a user of the cloud-based QC environment. In some cases the remote user interface includes, or has access to, one or more application programming interfaces (APIs), command line interfaces, graphical user interfaces, or other elements that expose the services of the computer system 101 to the user devices 110.

In some cases, the cloud-based QC environment may be deployed in a “serverless” computing architecture. For instance, the cloud-based QC environment may provide on-demand access to a shared pool of configurable computing resources (e.g., networks, servers, storage, applications, services, quantum computing resources, classical computing resources, etc.) that can be provisioned for requests from user devices 110. Moreover, the cloud-based computing systems 101 may include or utilize other types of computing resources, such as, for example, edge computing, fog computing, etc.

In an example implementation of a cloud-based QC environment, the servers 108 may operate as a cloud provider that dynamically manages the allocation and provisioning of physical computing resources (e.g., GPUs, CPUs, QPUs, etc.). Accordingly, the servers 108 may provide services by defining virtualized resources for each user account. For instance, the virtualized resources may be formatted as virtual machine images, virtual machines, containers, or virtualized resources that can be provisioned for a user account and configured by a user. In some cases, servers 108 include a container management and execution system that is implemented, for example, using KUBERNETES® or another software platform for container management. In some cases, the cloud-based QC environment is implemented using a resource such as, for example, OPENSTACK®. OPENSTACK® is an example of a software platform for cloud-based computing, which can be used to provide virtual servers and other virtual computing resources for users.

In some cases, the server 108 stores quantum machine images (QMI) for each user account. A quantum machine image may operate as a virtual computing resource for users of the cloud-based QC environment. For example, a QMI can provide a virtualized development and execution environment to develop and run programs (e.g., quantum programs or hybrid classical/quantum programs). When a QMI operates on the server 108, the QMI may engage either of the quantum processing units 102A, 102B, and interact with a remote user device (110B or 110C) to provide a user programming environment. The QMI may operate in close physical proximity to, and have a low-latency transmission line with, the quantum computing systems 103A, 103B. In some implementations, remote user devices connect with QMIs operating on the servers 108 through secure shell (SSH) or other protocols over the wide area network 115.

In some implementations, all or part of the computing system 101 operates as a hybrid computing environment. For example, quantum programs can be formatted as hybrid classical/quantum programs that include instructions for execution by one or more quantum computing resources and instructions for execution by one or more classical resources. The servers 108 can allocate quantum and classical computing resources in the hybrid computing environment, and delegate programs to the allocated computing resources for execution. The quantum computing resources in the hybrid environment may include, for example, one or more quantum processing units (QPUs), one or more quantum virtual machines (QVMs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in, and represented by, an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting schemes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

In some instances, all or part of the quantum processing unit 102A functions as a quantum processing unit, a quantum memory, or another type of subsystem. In some examples, the quantum processing unit 102A includes a quantum circuit system. The quantum circuit system may include qubit devices, readout devices, and possibly other devices that are used to store and process quantum information. In some cases, the quantum processing unit 102A includes a superconducting circuit, and the superconducting circuit includes qubit devices operatively coupled to each other by coupler devices. In certain examples, the qubit devices and the coupler devices are implemented as superconducting quantum circuit devices that include Josephson junctions, for example, in Superconducting QUantum Interference Device (SQUID) loops or other arrangements, and are controlled by radio-frequency signals, microwave signals, and bias signals delivered to the quantum processing unit 102A.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

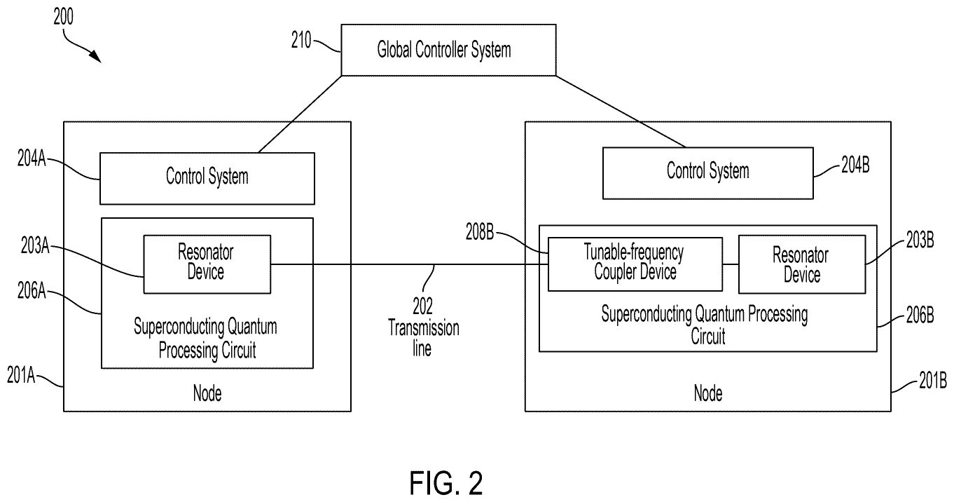

In some implementations, each of the quantum processing units 102 includes a superconducting quantum processing circuit (e.g., qubit devices, resonator devices, coupler devices, and other quantum circuit devices). In some instances, the superconducting quantum processing circuit of a quantum processing unit 102 may be implemented as the superconducting quantum processing circuit 206, 600,900, 940, 960 1000, 1100, in FIGS. 2, 6, 9A-9C, 10 and 11, or in another manner.

In some implementations, quantum processing units 102 in distinct controlled environments are communicably coupled together using transmission lines external to the controlled environments. In this case, a quantum state created on a resonator device of a first quantum processing unit 103A (e.g., an emitting node) can be transferred through the transmission line to a resonator device of the second quantum processing unit 103B (e.g., a receiving node) in the computing system 101. In some implementations, the computing environments 100 includes multiple computing systems 101. In this case, a quantum state generated on a resonator device of a superconducting quantum processing circuit of a quantum computing system in a first computing system 101 can be transferred to a resonator device of a superconducting quantum processing circuit of a quantum computing system in a second computing system via a transmission line communicably coupled between the first and second computing system 101.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems, or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computing system may include multiple quantum processing units, which may operate in the same controlled (e.g., cryogenic) environment or in separate environments.

In some implementations, control systems 105 associated with different quantum computing systems 103 in the same computing system 101 or different computing systems 101 are synchronized, for example through a global controller system in the wide area network 115, when control operations are executed on quantum processing units during a quantum state transferring process. In some implementations, during a time period when a signal carrying a quantum state is transferred a resonator device of an emitting node to a resonator device of a receiving node on a transmission line, one of the resonator devices in the pair has a tunable linewidth; and the other one of the resonator devices in the pair has a linewidth held at a fixed value. The tunable linewidth of the resonator device can be modified during the time period to minimize signal reflection from a receiving node back to an emitting node and to maximize the quantum state transfer efficiency. In some implementations, the tunable linewidth of the resonator device is modified by varying a magnetic flux pulse applied to a superconducting circuit loop of a tunable-frequency coupler device capacitively coupled to the resonator device. In some instances, the tunable linewidth of the resonator device can be varied in another manner.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations, or other types of operations. As an example, the signal hardware 104A may include arbitrary waveform generators (AWGs) that generate electromagnetic waveforms (e.g., microwave or radiofrequency) or laser systems that generate optical waveforms. The waveforms or other types of signals generated by the signal hardware 104A can be delivered to devices in the quantum processing unit 102A to operate qubit devices, readout devices, bias devices, coupler devices, or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radiofrequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers, and other types of components. In some instances, the signal delivery hardware performs preprocessing, signal conditioning, or other operations to the control signals to be delivered to the quantum processing unit 102A. In some instances, signal delivery hardware performs preprocessing, signal conditioning, or other operations on readout signals received from the quantum processing unit 102A.

The example controllers 106A communicate with the signal hardware 104A to control the operation of the quantum computing system 103A. The controllers 106A may include classical computing hardware that directly interface with components of the signal hardware 104A. The example controllers 106A may include classical processors, memory, clocks, digital circuitry, analog circuitry, and other types of systems or subsystems. The classical processors may include one or more single-or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in one or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bitstring representing qubit state measurements for a single execution of the quantum program, and a collection of bitstrings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computing system 103B and its components (e.g., the quantum processing unit 102B, the signal hardware 104B, and controllers 106B) can be implemented as described above with respect to the quantum computing system 103A; in some cases, the quantum computing system 103B and its components may be implemented or may operate in another manner.

In some implementations, the quantum computing systems 103A, 103B are disparate systems that provide distinct modalities of quantum computation. For example, the computer system 101 may include both an adiabatic quantum computing system and a gate-based quantum computer system. As another example, the computer system 101 may include a superconducting circuit-based quantum computing system and an ion trap-based quantum computer system. In such cases, the computer system 101 may utilize each quantum computing system according to the type of quantum program that is being executed, according to availability or capacity, or based on other considerations.

FIG. 2 is a block diagram showing aspects of an example computing network 200. The example computing network 200 includes multiple nodes 201 each including a superconducting quantum processing circuit 206. A superconducting quantum processing circuit 206 includes one or more resonator devices 203 and other quantum circuit devices connected by superconducting circuitry. A node 201 of the computing network 200 is communicably coupled to one or more other nodes 201 via respective transmission lines 202 which directly couple respective superconducting quantum processing circuits 206. Each node is also further communicably coupled to a global controller system210, for example, through the control systems 204. As shown in FIG. 2, the superconducting quantum processing circuit 206A of the first node 201A and the superconducting quantum processing circuit 206B of the second node 201B, are communicably coupled through a transmission line 202. The superconducting quantum processing circuits 206A, 206B reside in respective controlled environment (e.g., cryogenic environment), and at least a portion of the transmission line 202 is external to the respective controlled environments. The control system 204A of the first node 201A and the control system 204B of the second node 201B are communicably coupled to the global controller system 210.

In some instances, a quantum state of a resonator device in a node can be transferred to another resonator device in another node through the computing network 200. In some instances, the example computing network 200 can be also used to perform other operations, e.g., distributed quantum computing. In some implementations, the first and second nodes 201A, 201B are implemented as the quantum computing system 103A, 103B. The control system 204 and the superconducting quantum processing circuit 206 may be implemented as the control system 105 and the quantum processing unit 102 in FIG. 1, respectively. In some implementations, the example computing network 200 may include additional and different features or components and components of the example computing network 200 may be implemented in another manner.

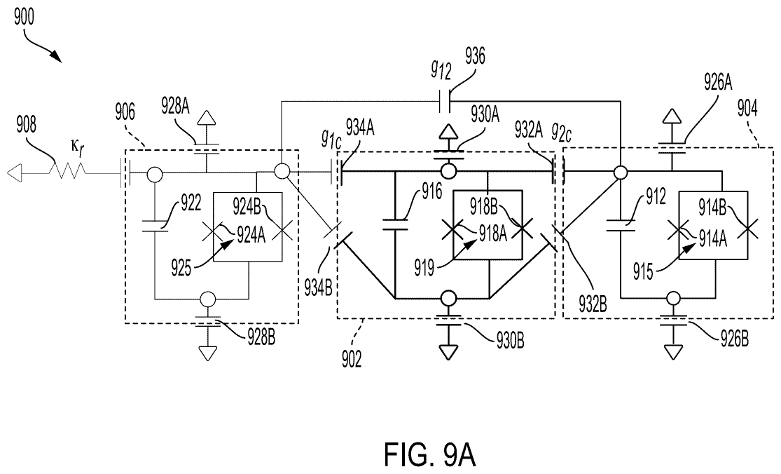

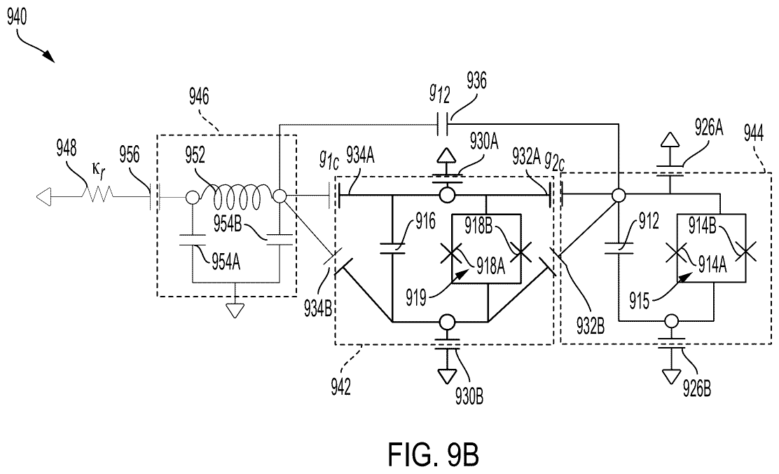

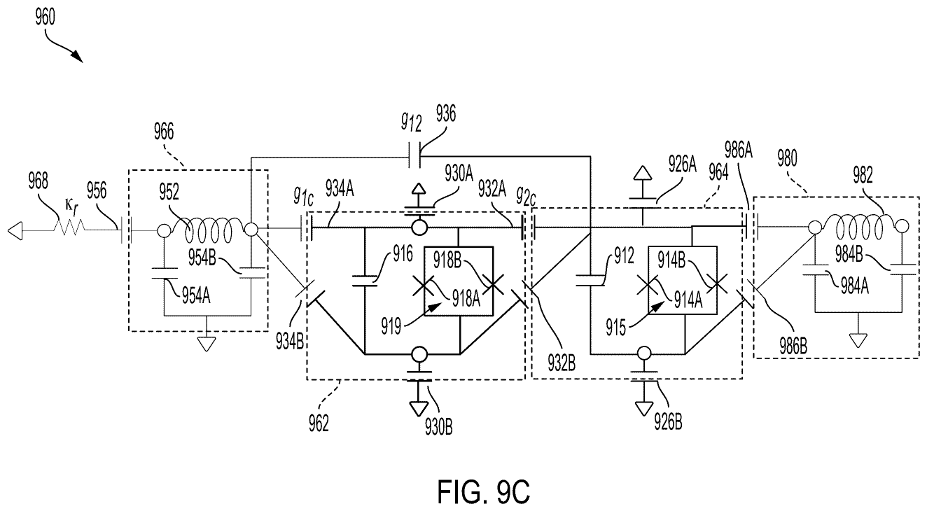

In some implementations, a resonator device 203 in a superconducting quantum processing circuit 206 of a node 201 is a qubit device. A qubit device has two eigenstates that are used as computational basis states (e.g., |0 [symbol] and |1 [symbol] ), and each qubit device can transition between its computational basis states or exist in an arbitrary superposition of its computational basis states. In some examples, the two lowest energy levels (e.g., the ground state and first excited state) of a qubit device are defined as a qubit and used as computational basis states for quantum computation. In some examples, higher energy levels (e.g., a second excited state or a third excited state) can be used to define a qubit, a qutrit, or a multi-level quantum computational device in some instances. Quantum states (e.g., qubits) of a qubit device can be manipulated by control signals. In some cases, readout devices (e.g., the readout device 980 of the example equivalent circuit 960 in FIG. 9C) can detect the states of the qubit device, for example, by interacting directly with the respective qubit devices. In some cases, the quantum state of the qubit device can be transmitted to another resonator device (e.g., another qubit device of another storage device) of another node by performing a quantum state transfer process (e.g., operations in the example process 700 or in another manner).

In some examples, a transition frequency of a qubit device is tunable (e.g., a tunable-frequency qubit device), for example, by application of an offset field. In some instances, a superconducting tunable-frequency qubit device may include a tunable transmon qubit device, a flux qubit device, a capacitively shunted flux qubit device, a flatsonium qubit device, a fluxonium qubit device, or another type of tunable-frequency qubit device. In some implementations, a tunable-frequency qubit device includes a superconducting circuit loop (e.g., a SQUID loop), which can receive a magnetic flux that tunes the transition frequency of the tunable-frequency qubit device. As an example, the superconducting circuit loop may include two Josephson junctions connected in parallel, and the tunable-frequency qubit device may also include a shunt capacitor in parallel with the two Josephson junctions. For another example, the superconducting circuit loop may include three Josephson junctions, a single Josephson junction, and a linear indicator in parallel, or another loop. In some implementations, the transition frequency of the tunable-frequency qubit device may be defined at least in part by Josephson energies of the two Josephson junctions, a capacitance of the shunt capacitor, and a magnetic flux threading the superconducting circuit loop. In some implementations, the resonator device 203B may be implemented as the resonator device 904, 944, 964 in FIGS. 9A-9C, or in another manner.

In some examples, the transition frequency of a qubit device is not tunable by application of an offset field and is independent of magnetic flux experienced by the qubit device. For instance, a fixed-frequency qubit device may have a fixed transition frequency that is defined by an electronic circuit of the qubit device. As an example, a fixed-frequency qubit device (e.g., a fixed-frequency transmon qubit device) may be implemented without a SQUID loop. In some examples, the fixed-frequency qubit device includes one Josephson junction and a shunt capacitor, and the transition frequency of the fixed-frequency qubit device is defined at least in part by a Josephson energy of the Josephson junction and a capacitance of the shunt capacitor, which is independent of a magnetic flux experienced by the fixed-frequency qubit device.

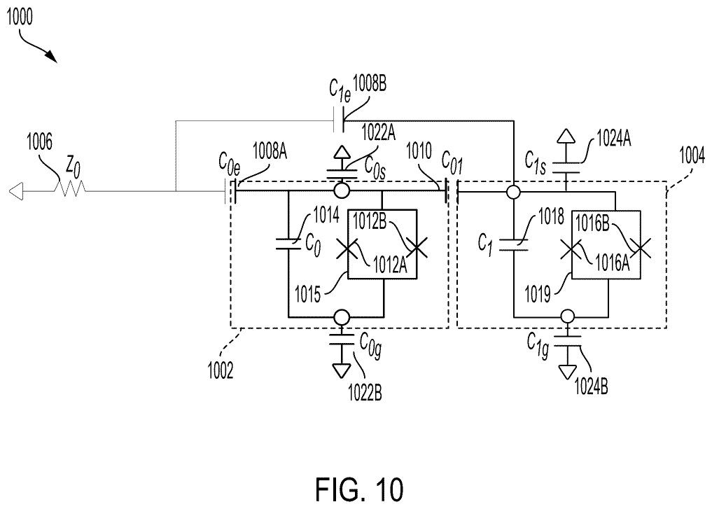

In certain instances, a qubit device includes one qubit electrode. In this case, the qubit device is considered as a “grounded” qubit device when the one or more Josephson junctions of the qubit device are connected between the qubit electrode and a ground plane (e.g., two or more Josephson junctions may be connected in parallel between the qubit electrode and a ground plane); and the shunt capacitor is defined by capacitance between the qubit electrode and the ground plane. In other instances, a qubit device includes two qubit electrodes. In this case, the qubit device is considered as a “floating” qubit device when the one or more Josephson junctions of the qubit device are connected between the two qubit electrodes that are not directly connected to ground (e.g., two or more Josephson junctions may be connected in parallel between the two qubit electrodes, as in the examples shown in FIGS. 9A-9C, and 10); and the shunt capacitor is defined by capacitance between the two qubit electrodes.

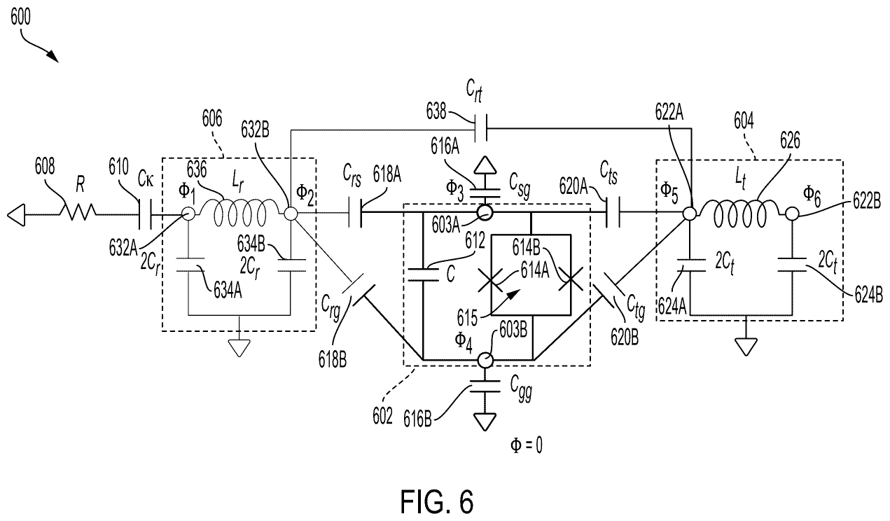

In some implementations, a resonator device 203 of a node 201 is a storage device (e.g., an inductor-capacitor resonator device). The resonator device 203, in this case, has a fixed resonance frequency. In certain instances, the storage device includes two resonator electrodes galvanically connected by a linear inductor. The two resonator electrodes are not directly connected to the ground plane. The resonance frequency of the storage device is defined at least by the inductance of the linear inductor and the capacitances of the shunt capacitors between each of the resonator electrodes and the ground plane. In some implementations, the resonator device 203 may be implemented as the resonator device 604 in FIG. 6, or in another manner.

As shown in FIG. 2, the superconducting quantum processing circuit 206B of the second node 201B of the computing network 200 further includes a tunable-frequency coupler device 208B communicably coupled to the resonator device 203B. The tunable-frequency coupler device 208B may be implemented by transmon qubit devices, flux qubit devices, flatsonium qubit devices, fluxonium qubit devices, or other types of tunable-frequency qubit devices. In some implementations, the transition frequency of a tunable-frequency coupler device 208B is tunable, for example, by application of an offset field. For instance, a tunable-frequency qubit device 208B may include a superconducting loop (e.g., a SQUID loop), which can receive a magnetic flux that tunes the qubit frequency of the tunable-frequency qubit device 208B. The transition frequency is also known as “resonant frequency” or “fundamental frequency”, which is defined by the energy difference between the first and second excited states of the qubit divided by Planck's constant (e.g., according to ω=E/ℏ). The transition frequency also defines the operating frequency of the tunable-frequency qubit device 208B. The tunable-frequency qubit device 208B may be implemented as a tunable-frequency transmon qubit device or another type of tunable-frequency qubit device. For example, the tunable-frequency qubit device 208B may include two Josephson junctions connected in parallel with each other to form a SQUID loop, which resides adjacent to a control signal line (e.g., a flux-bias control line). In some implementations, the transition frequency of the tunable-frequency qubit device may be defined at least in part by Josephson energies of the two Josephson junctions, a capacitance of the shunt capacitor, and a magnetic flux threading the superconducting circuit loop. In some implementations, the tunable-frequency coupler device 208B may be implemented as the tunable-frequency qubit devices 602, 902, 942, 962, 1002 in FIGS. 6, 9A-9C, 10, or in another manner.

In some instances, when a tunable-frequency coupler device 208B includes two coupler electrodes, the two coupler electrodes are electrically floating at a certain potential without being conductively connected to a ground plane. In other words, neither of the two coupler electrodes is conductively coupled to ground. In this case, the two coupler electrodes of the coupler device can be capacitively coupled to the ground plane, e.g., through a residual capacitance between each of the two coupler electrodes and the ground plane (e.g., as the tunable-frequency coupler device 602, 902, 942, 962, 1002, 1104 as shown in FIGS. 6, 9A-9C and 10 or in another manner). In some instances, when a tunable-frequency coupler device 208B includes one coupler electrodes, the tunable-frequency coupler device 208B is grounded, in which the two or more Josephson junctions of the tunable-frequency coupler device 208B are connected in parallel between the coupler electrode and the ground plane; and the shunt capacitor is defined by capacitance between the coupler electrode and the ground plane.

In some implementations, the coupling between the tunable-frequency coupler device 208B and the resonator device 203B is capacitive, for example, between one or more coupler electrodes and one or more qubit electrodes or resonator electrodes. In some instances, a resonator device 203B of the node 201B may be paired with one or more tunable-frequency coupler device 208B of the same node 201B for receiving signals from or transmitting signals to different resonator devices 203 of different nodes 201.

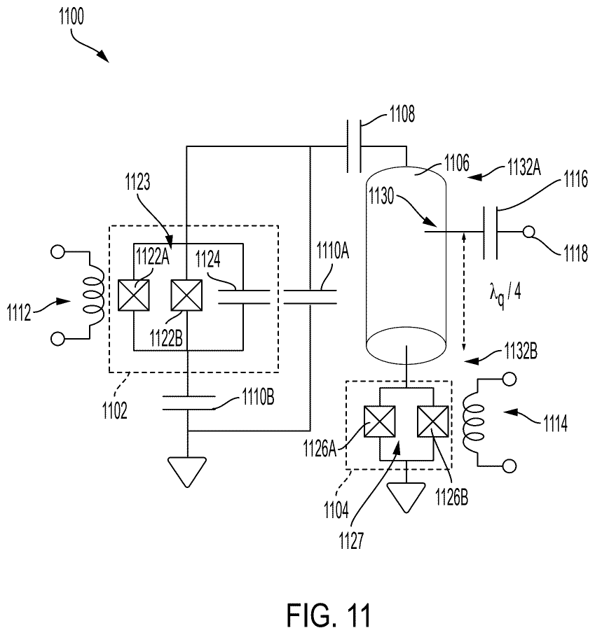

As shown in FIG. 2, the tunable-frequency coupler device 208B is further communicably coupled to the transmission line 202. In some instances, the tunable-frequency coupler device 208B may be coupled to the transmission line 202 directly (e.g., in the example shown in FIGS. 10 and 11) or through a buffer resonator device (e.g., in the example shown in FIGS. 6, 9A-9C). In certain example, a buffer resonator device may be implemented as the resonator device 203B, e.g., a tunable-frequency qubit device (e.g., the tunable-frequency qubit device 906, 946, 966) or a storage device (e.g., the buffer resonator device 606 in FIG. 6).

In some implementations, the superconducting quantum processing circuit 206B includes flux bias control lines which can provide magnetic flux locally to the tunable-frequency coupler device 208B to tune its transition frequency. In some instances, the superconducting quantum processing circuit 206B may include additional flux bias control lines which can provide magnetic flux locally to the tunable-frequency qubit devices to tune their respective frequencies. In some instances, the superconducting quantum processing circuit 206B may include microwave feedlines, and readout resonator devices (e.g., the readout resonator device 968 as shown in FIG. 9C) to readout qubits. In some examples, the superconducting quantum processing circuit 206B may include microwave feedlines which are coupled to one or several of the readout resonator devices to allow microwave excitation of the readout resonator devices used to readout qubits. In this case, the superconducting quantum processing circuit 206B may include microwave drive lines which are capacitively coupled to the tunable-frequency qubit devices to drive qubits. The superconducting quantum processing circuit 206B may further include filters, isolators, circulators, amplifiers, or other circuit elements.

In this case, the tunable-frequency qubit device 208B enables parametric control to coherently absorb microwave radiation from the transmission line 202 to the resonator device 203B with tunable coupling strengths, allowing for pulse shaping the absorption process. In other words, tuning the coupling strength between the resonator device 203B and the transmission line 202 and thus, the effective linewidth of the resonator device 203B can be used to reduce back reflection and improve the efficiency of the quantum state transferring process.

In some implementations, the transmission line 202 is configured for coherent transmission of quantum states between resonator devices 203 of two distinct nodes 201 in the computing network 200. In some implementations, the transmission line 202 is unidirectional. For example, a quantum state created on the first node 201A can be transferred to the second node 201B through the respective transmission line 202. In some implementations, the quantum state transferring process through the transmission line 202 is bidirectional. In this case, a quantum state created on the second node 201B can be also transferred to the first node 201A via the same transmission line 202. The second node 201B may be a receiving node that receives a quantum state from the first node 201A, an emitting node that transmits a quantum state to the first node 201A, or an intermediate node that transmits the same quantum state received from the first node 201A to another node (e.g., a third distinct node).

In some instances, the transmission line 202 may be an optical channel with optical circuit elements (e.g., switches, photodetectors, transducers, optical fibers, etc.). In this case, the nodes 201 may include transducer devices that convert between signals in a microwave-frequency regime and an optical-frequency regime; and the signal carrying a quantum state is an optical signal. In some instances, the transmission line 202 may be a microwave channel with microwave circuit elements (e.g., superconducting transmission lines, a microwave coaxial cable, microwave filters, circulator, etc.); and the signal carrying the quantum state is a microwave signal. In certain instances, the transmission line 202 may be another type of communication channel.

In some instances, each node 201 may be communicably coupled to two or more nodes 201 through distinct transmission lines 202. For example, the second node 206B may receive a quantum state from the first node 201A and further transfer the quantum state or a new quantum state from a different resonator device to a third node. In some instances, the resonator devices 203A, 203B of the first and second nodes 201A, 201B may be selectively coupled to the transmission line 202, e.g., by operation of the control system 204A, 204B.

In some instances, the control system 204 delivers control signals to the superconducting quantum processing circuit 206 or other elements in the respective node 201. The control signals can be configured to manipulate the qubits defined by the qubit devices. In some implementations, a control signal can be a direct current (DC) signal communicated from the control system 204 to the individual qubit device. In some implementations, a control signal can be an alternating current (AC) signal communicated from the control system 204 to the individual qubit device. In some cases, the AC signal may be superposed with a direct current (DC) signal. Other types of control signals may be used. In certain instances, the control system 204 shown in FIG. 2 may include, for example, a signal generator system, a program interface, a signal processing system, and possibly other system components.

In certain instances, the control system 204 can also receive readout signals from the resonator device 203 of the superconducting quantum processing circuit 206. In certain instances, the control system 204 includes connector hardware elements which include signal lines, signal processing hardware, filters, feedthrough devices (e.g., light-tight feedthroughs, etc.), and other types of components. In some implementations, the connector hardware elements of the control system 204 can span multiple different temperature and noise regimes. For example, the connector hardware elements can include a series of thermal stages operating at different temperatures, e.g., 60 Kelvin (K), 3 K, 800 milli Kelvin (mK), 150 mK, that decrease between a higher temperature regime of the global controller system 210 and the control system 204 and a lower temperature regime of the superconducting quantum processing circuit 206B. In some instances, components of the control system 204 can operate in a room temperature regime, an intermediate temperature regime, or both. For example, the control system 204 can be configured to operate at much higher temperatures and be subject to much higher levels of noise than are present in the environment of the superconducting quantum processing circuit 206.

In some implementations, the superconducting quantum processing circuit 206 and part of the control system 204 can be maintained in a controlled cryogenic environment, (e.g., cooled using liquid helium). One or more electrically conductive layers (or at least a portion) in the superconducting quantum processing circuit 206 can operate as a superconducting layer at that temperature. The environment can be provided, for example, by shielding equipment, cryogenic equipment, and other types of environmental control systems. In some examples, the superconducting circuitry and the quantum circuit devices in the superconducting quantum processing circuit 206 operate in a cryogenic temperature regime and are subject to very low electromagnetic and thermal noise. For example, magnetic shielding can be used to shield the system components from stray magnetic fields, optical shielding can be used to shield the system components from optical noise, and thermal shielding and cryogenic equipment can be used to maintain the system components at controlled temperatures, etc.

In some aspects of operation, the control system 204 sends control signals to the tunable-frequency coupler device 208B and other quantum circuit devices of the superconducting quantum processing circuit 206. In some implementation, by operation of the control system 204B, the effective linewidth of the respective resonator device 203B can be modified while the signal transfers a quantum state on the transmission line 202 to the resonator device 203B of the second node 201B from the resonator device 203A of the first node 201A. During the quantum state transfer process, the linewidth of the resonator device 203A of the first node 201A remains constant at a fixed value; and the effective linewidth of the resonator device 203B of the second node 201B is tunable and can be modified by tuning the magnetic flux pulse applied on the tunable-frequency coupler device 208B that is capacitively coupled to the resonator device 203B. Performance of the quantum state transfer process (e.g., efficiency, fidelity, etc.) can be optimized by optimizing the time profile of the effective linewidth of the resonator device 203B

In some implementations, the global controller system 206 includes classical computing resources (e.g., CPU, GPU, etc.) that can be used to determine the time profile of the effective linewidth of the resonator device 203B. For example, the global controller system 206 can receive information regarding the first and second nodes 201A, 201B (e.g., device parameters of the resonator devices 203A, 203B and the tunable-frequency coupler device 208B, availability of quantum computing resources, etc.), determine values of the effective linewidth of the resonator devices 203B for a maximized quantum state transfer efficiency, determine a time delay between the first and second nodes 201A, 201B, and synchronizing or coordinating control operations on the respective nodes 201A, 201B during the quantum state transferring process. The global control system 210 in FIG. 2 can generate instructions of the transfer protocol for the first and second nodes 201A, 201B. In some implementations, the global control system 210 triggers signal generation after the instructions are generated and communicated to the control system 204A of the first node 201A and the control system 204B of the second node 201B in FIG. 2. In some implementations, the global controller system 210 may be configured to perform other types of operations.

In some instances, the global controller system 210 identifies a pair of resonator devices 203 in the superconducting quantum processing circuits 206 of nodes 201 between which a quantum state transfer process is executed; and determines a time profile of an effective linewidth of the resonator device 203B of the node 206B. The time profile of the effective linewidth of the resonator device 203B is then transmitted back to the control system 204B of the second node 201B, on which a particular control schedule can be determined to achieve a specific quantum state transferring performance according to the time profile of the effective linewidth of the resonator device 203B. In some implementations, a control schedule includes control signals defined by control parameters and their relative timing.

As a particular example, FIG. 6 shows an equivalent circuit of example tunable-frequency qubit device 602, which include respective superconducting circuit loops 912, 914. Each of the respective superconducting circuit loop 615 can receive a magnetic flux Φ(t) that controls the transition frequency of the example tunable-frequency qubit device 602. Manipulating the magnetic flux Φ(t) through the superconducting circuit loop 615, can increase or decrease the transition frequencies of the example tunable-frequency floating qubit device 602. In this example, the magnetic flux Φ(t) through the superconducting circuit loop 615 is offset fields that can be modified in order to tune the transition frequencies of the tunable-frequency coupler device 602. In some cases, inductors or other types of flux bias elements as part of control lines carrying the control signals are coupled to the respective superconducting circuit loop 615 by respective mutual inductances, and the magnetic flux Φ(t) through the superconducting circuit loop 615 can be controlled by the current through the inductors.

In certain examples, an offset field can be, for example, a magnetic flux bias, a DC electrical voltage, or another type of field. In some implementations, the tunability of the tunable-frequency coupler device 208B, in the superconducting quantum processing circuit 206B allows selectively coupling of the resonator device 203B to the transmission line 202 on-demand to perform a quantum state transfer process, or to perform other types of control operations. The effective coupling strength provided by control of the tunable-frequency coupler device 208B to activate or deactivate the coupling of the resonator device to the transmission line 202 or to a buffer resonator device (e.g., the buffer resonator device 606, 906, 946, 966 in FIGS. 6, 9A-9C or in another manner).

In some aspects of operation, the control system 204B communicates control signals to the resonator device 203B in the superconducting quantum processing circuit 206B. The control signals can be configured to modulate, increase, decrease, or otherwise manipulate the transition frequencies of the tunable-frequency coupler device 208B, the resonator device 203B (e.g., when the resonator devices are tunable-frequency qubit devices), or other operations. In some implementations, a control signal includes a flux bias signal that varies a magnetic flux experienced by the tunable-frequency coupler device, and varying the magnetic flux can change the transition frequency of the tunable-frequency coupler device. A control signal includes a flux modulation signal that is configured to modulate a transition frequency of a tunable-frequency coupler device at a certain flux modulation frequency and a certain flux modulation amplitude. A control signal includes a microwave drive signal that is configured to drive the qubit at the transition. For example, a microwave signal to excite the qubit can be transmitted to a qubit device of a transmitting node. The qubit energy is then transferred to a resonator device coupled to the qubit device of the transmitting node. The signal from the resonator is then propagated through a transmission line to be captured at the receiving node. A control signal can be a direct current (DC) signal communicated from the control system 204 to the individual quantum circuit device (e.g., the tunable-frequency coupler device 208B and the resonator device 203). In some implementations, a control signal can be an alternating current (AC) signal communicated from the control system 204 to the individual quantum circuit device. In some cases, the AC signal may be superposed with a direct current (DC) signal. Other types of control signals may be used.

In some implementations, the control signals are configured to generate interactions that perform quantum state transfer between a selected pair of resonator devices 203 of a pair of nodes 201. A control signal 206 may be a current signal, a voltage signal, or another type of electrical signal which can be used to control a control line, for example with a flux bias element, to modulate a flux bias signal so as to modulate a magnetic flux and generate a modulated magnetic flux (e.g., a modulated flux bias). In this case, the control signals tune transition frequencies of a resonator device and a buffer resonator device, and/or tuning a transition frequency of the tunable-frequency coupler device 208B.

In some cases, when a resonator device 203 is a tunable-frequency qubit device, the control line (which receives the control signal) may include a flux bias element that is inductively coupled to a superconducting circuit loop of the tunable-frequency qubit device to control the magnetic flux through the superconducting circuit loop in the tunable-frequency qubit device. The control signal may cause the flux bias element to modulate the magnetic flux at a flux modulation frequency.

In some implementations, the control signal can be further configured to perform a calibration process to determine device parameters and control parameters for transferring a quantum state; for enabling and disabling the coupling between the two resonator devices, and for other control operations. In some implementations, the control system 204A, 204B, or another type of system associated with the nodes 201A, 201B, determines control parameters for controlling the time profile of the effective linewidth of the resonator device 203B. For example, values of the control parameters for the control signal may be determined by a calibration process defined in software, firmware, or hardware or a combination thereof. In some cases, the control system 204A, 204B executes a calibration process when the superconducting quantum processing circuit 206 is first installed for use in the computing network 200, and the calibration process may be repeated at other times (e.g., as needed, periodically, according to a calibration schedule, etc.). For instance, a calibration module of the control systems 204A, 204B may execute a calibration process that obtains values of device parameters of the resonator devices 203A, 203B and the tunable-frequency coupler devices 208B in the superconducting quantum processing circuit 206A, 206B. For example, the device parameters include a range of qubit operating frequency and anharmonicity of the resonator device 203A, 203B (e.g., when the resonator devices 203 are tunable-frequency qubit devices), an operating frequency and anharmonicity of the tunable-frequency coupler device 203B (e.g., when resonator devices 203 are fixed-frequency qubit devices), or other parameters.

To perform the calibration, the control system of the first node generates calibration signals, and the calibration signals are delivered to the superconducting quantum processing circuit of the first node. The calibration signals can include, for example, microwave pulses applied to individual circuit devices (e.g., qubit devices), flux bias signals applied to individual coupler devices (e.g., tunable-frequency coupler devices), or other types of signals. The control system then obtains calibration measurements from the superconducting quantum processing circuit, and the control system uses the calibration measurements to determine the control parameters. For instance, the control system 204B can identify calibration signals that are configured to execute a pre-defined calibration routine, and the calibration signals can then be generated by the signal hardware of the control system and delivered to quantum circuit devices (e.g., qubit devices) in the supeconducting quantum processing circuit 206B. The pre-defined calibration routine can include, for example, the types of experiments, measurements, processes, optimization criteria or other features described in U.S. Pat. No. 10,282,675 entitled “Performing a Calibration Process in a Quantum Computing System;” other types of calibration routines may be used in some cases. During the calibration process, the control system 204B obtains calibration measurements from the superconducting quantum processing circuit 206B and uses the calibration measurements in the calibration routine, for instance, to identify an improved or optimal value of one or more control paramters. The calibration measurements may include readout signals from readout resonator devices or other types of measurements obtained from the superconducting quantum processing circuit 206B. The control parameters that are modified based on the calibration measurements can include, for example, the amplitude (power), frequency, duration, or phase of a microwave pulse; the amplitude (power), frequency, duration, or phase of a flux bias signal; or other types of control parameters for control signals.

In some implementations, calibration signals are generated by operation of the control system 204B in FIG. 2 according to values of the control parameters (e.g., the initial values of the control parameters determined based on the device parameters, or the improved values determined during the calibration process) and delivered to respective quantum circuit devices of the superconducting quantum processing circuit (e.g., the resonator device 203B and the tunable-frequency coupler device 208B). In order to perform a calibration measurement, calibration signals are communicated to respective quantum circuit devices to perform operations on the respective quantum circuit devices, e.g., tuning the effective coupling strength between two resonator device and a buffer resonator device, tuning the transition frequencies of tunable-frequency qubit/coupler devices, and other operations.

In some cases, the calibration process may include a continuous-wave (CW) characterization procedure, which may include cavity spectroscopy measurements, qubit spectroscopy measurements, T1 and T2 measurements, and others. In some cases, the calibration process can include a pulsed characterization procedure, which may include cavity spectroscopy measurements, Rabi spectroscopy measurements, Ramsey spectroscopy measurements, power Rabi measurements, T1 and T2 measurements, and others. The CW or pulsed characterization procedures may perform measurements to detect the quality factor, resonance frequency, Lamb shift and other parameters of a device.

In some instances, the values of the device parameters are used to determine values of control parameters for the control signals. In some implementations, the control parameters for the control signal in a control schedule may include the relative duration, relative phase, or another parameter. When the resonator device 203B are tunable-frequency qubit devices, the control signal with the determined control parameters can be applied to the resonator device 203B, the buffer resonator device and the tunable-frequency coupler device 208B to bring the resonator device 203B on resonance with the buffer resonator device. In this case, the control signal can vary values of the magnetic flux applied to the tunable-frequency coupler device 208B to determine a parking value which causes a coupling strength between the tunable-frequency coupler device 208B and the resonator device 203B to vanish or to be less than or equal to a predetermined threshold value. The control signal can vary values of the magnetic flux applied to the tunable-frequency coupler device 208B to determine an activating value which corresponds to a maximal value of the coupling strength.

In certain instances, resonator devices 203A, 203B in the superconducting quantum processing circuit 206A, 206B are arranged in a rectilinear (e.g., rectangular, or square) array that extends in two spatial dimensions (e.g., in the plane of the page), or in another type of ordered array. In some instances, the rectilinear array also extends in a third spatial dimension (e.g., in/out of the page), for example, to form a cubic array or another type of three-dimensional array.

In some instances, the superconducting quantum processing circuit 206A, 206B can each be supported by a substrate. In some implementations, the substrate may include a dielectric substrate (e.g., silicon, sapphire, etc.). In certain examples, the substrate may include an elemental semiconductor material such as, for example, silicon (Si), germanium (Ge), selenium (Se), tellurium (Te), or another elemental semiconductor. In some instances, the substrate may also include a compound semiconductor such as silicon germanium (SiGe), silicon carbide (SiC), silicon germanium carbide (SiGeC), aluminum oxide (sapphire), gallium arsenide (GaAs), indium arsenide (InAs), indium phosphide (InP), gallium arsenic phosphide (GaAsP), or gallium indium phosphide (GalnP). In some instances, the substrate may also include a superlattice with elemental or compound semiconductor layers. In some instances, the substrate may include an epitaxial layer. In some examples, the substrate may have an epitaxial layer overlying a bulk semiconductor or may include a semiconductor-on-insulator (SOI) structure.

In some instances, the superconducting quantum processing circuit 206A, 206B each may include superconducting materials. In some implementations, the superconducting materials may be superconducting metals, such as aluminum (Al), niobium (Nb), tantalum (Ta), vanadium (V), tungsten (W), indium (In), titanium (Ti), Lanthanum (La), lead (Pb), tin (Sn), and/or zirconium (Zr), that are superconducting at an operating temperature of the superconducting quantum processing circuit 206A, 206B, or another superconducting metal. In certain instances, the superconducting materials may include superconducting metal alloys, such as molybdenum-rhenium (Mo/Re), niobium-tin (Nb/Sn), or another superconducting metal alloy. In some implementations, the superconducting materials may include superconducting compound materials, including superconducting metal nitrides and superconducting metal oxides, such as titanium-nitride (TiN), niobium-nitride (NbN), zirconium-nitride (ZrN), hafnium-nitride (HfN), vanadium-nitride (VN), tantalum-nitride (TaN), molybdenum-nitride (MoN), yttrium barium copper oxide (Y—Ba—Cu—O), or another superconducting compound material. In some instances, the superconducting materials may include multilayer superconductor-insulator heterostructures.

In some instances, the superconducting quantum processing circuit 206A, 206B in the nodes 201A, 201B can be formed on surfaces of the substrate and patterned using a microfabrication process or in another manner. For example, the superconducting circuit elements in the superconducting quantum processing circuit 206A, 206B may be formed by performing at least some of the following fabrication processes: using chemical vapor deposition (CVD), physical vapor deposition (PVD), atomic layer deposition (ALD), and/or other suitable techniques to deposit respective superconducting layers on the substrates; and performing one or more patterning processes (e.g., a lithography process, a dry/wet etching process, a soft/hard baking process, a cleaning process, etc.) to form openings in the respective superconducting layers.

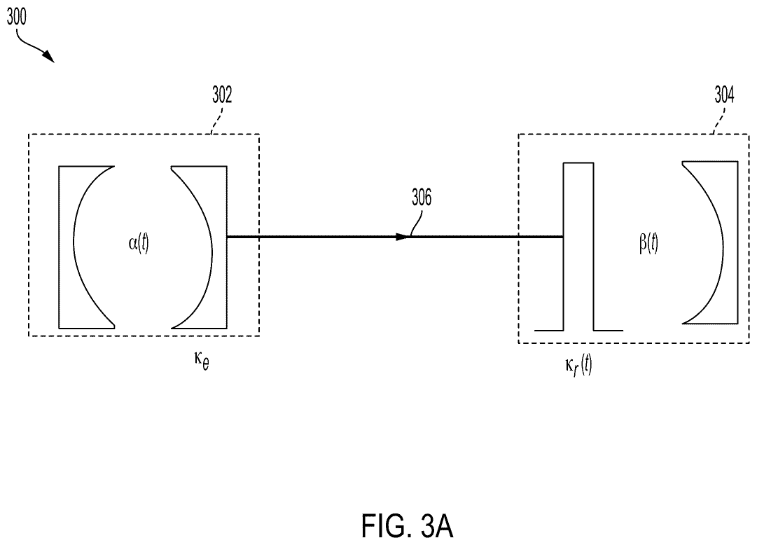

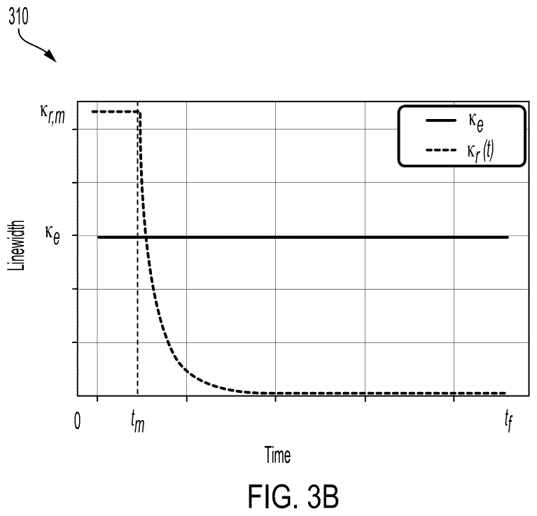

FIG. 3A is a schematic diagram showing aspects of an example computing network 300. The example computing network 300 includes a first resonator device 302 and a second resonator device 304 communicably coupled to the first resonator device 302 through a transmission line 306. As shown in FIG. 3A, the first resonator device 302 resides on an emitting node on which a quantum state is created; and the second resonator device 304 resides on a remote receiving node. The quantum state can be transferred by a signal on the transmission line 306 from the first resonator device 302 to the second resonator device 304. In some implementations, the first resonator device 302 is implemented as the resonator device 203A; and the second resonator device 304 is implemented as the resonator device 203B and the tunable-frequency coupler device 208B. The computing network 300 may include additional or different features, and the components of a computing environment may operate as described with respect to FIG. 3A or in another manner.

The first resonator device 302 of the emitting node has a resonance frequency ωₑ; and the second resonator device 304 of the receiving node has a resonance frequency ωᵣ. A high transfer efficiency for quantum state transfer between the first and second resonator devices 302, 304 can be realized by cancelling otherwise reducing the back reflection of the signal at the second resonator device 304. In some implementations, back reflection is canceled by designing a time profile of an effective linewidth of the second resonator device 304 so that the field emitted has an exponentially decreasing waveform that allows destructive interference at the second resonator device 304. In some instances, during a quantum state transferring process, the first resonator device 302 of the emitting node has a linewidth at a fixed value κₑ; and the second resonator device 302 of the emitting node has a tunable effective linewidth κᵣ(t) that varies as a function of time. When the time profile of the effective linewidth of the second resonator device 304 is configured in a certain fashion (e.g., following a pulse shape described in Equation (9) below), a maximum value of the transfer efficiency of the quantum state from the first resonator device 302 to the second resonator device 304 can be obtained.

In some implementations, a quantum state transferred between the first and second resonator devices 302, 304 communicably coupled by the transmission line 306 can be modeled by quantum Langevin equations as described below:

$$\dot{a} ( t ) = - \frac{{κ}_{e}}{2} a ( t ) + i Δ a ( t ) + \sqrt{{κ}_{e}} {a}_{in} ( t ) , \qquad ( 1 )$$

$$\dot{b} ( t ) = - \frac{{κ}_{r}}{2} b ( t ) + i Δ b ( t ) + \sqrt{{κ}_{r}} {b}_{in} ( t )$$

where ωₑ and ωᵣ are the resonance frequencies of the respective resonator devices 302, 304; Δ is a frequency offset, e.g., Δ=ωₑ−ωᵣ; a and b are the annihilation operators for the respective resonator devices 302, 304, κₑ and κᵣ are the damping (e.g., linewidths) of the respective resonator devices 302, 304; and aᵢₙ and bᵢₙ are the input signals to the respective resonator devices 302, 304. The signal transmission on the transmission line 306 is unidirectional from the first resonator device 302 to the second resonator device 304. In some instances, κₑ can be specified as a device parameter when the resonator device is designed or predetermined in another manner. For example, the transmission line 306 may include a directional coupler for unidirectional transmission. In this case, the output of the first resonator device 302 is an input to the second resonator device 304 with a time delay τ, e.g., aₒᵤₜ(t−τ)=bᵢₙ(t). Thus, using the input-output theory, the output of the first resonator device 302 can be determined as follows:

$${a}_{out} = \sqrt{{κ}_{e} ( t )} a ( t ) - {a}_{in} ( t ) , \qquad ( 2 )$$

$${b}_{in} = \sqrt{{κ}_{e}} a ( t - τ ) - {a}_{in} ( t - τ )$$

In view of this, the equation for the resonator mode operator b becomes:

$$\dot{b} ( t ) = - \frac{{κ}_{r}}{2} b ( t ) + i Δ b ( t ) + \sqrt{{κ}_{r} {κ}_{e}} a ( t - τ ) - \sqrt{{κ}_{r}} {a}_{in} ( t - τ ) \qquad ( 3 )$$

Furthermore, due to the unidirectional coupling, the equation for a is decoupled from that of b. The time delay τ can be eliminated (e.g., τ→0) from the equations by defining a “time-delayed” operators for the first resonator device 302 as ã(τ)≡a(t−τ). The first and second resonator devices 302, 304 are coupled to vacuum (e.g., zero temperature environment). This implies [symbol] aᵢₙ(t) [symbol] = [symbol] ãᵢₙ(t−τ) [symbol] =0 and the equations are equivalent to the classical equations:

$$\dot{α} ( t ) = - \frac{{κ}_{e}}{2} α ( t ) + i Δα ( t ) \qquad ( 4 )$$

$$\dot{β} ( t ) = - \frac{{κ}_{r} ( t )}{2} β ( t ) + i Δβ ( t ) + \sqrt{{κ}_{e} {κ}_{r}} α ( t )$$

where α(t)= [symbol] (a(t) [symbol] and β(t)= [symbol] (b(t) [symbol] . It is assumed that the first and second resonator devices 302, 304 are in resonance, e.g., Δ=0, in order to maximize the quantum state transfer efficiency between the first and second resonator devices 302, 304. A formal solution of the equation for β(t) can be expressed as

$$β ( t ) = β ( 0 ) {e}^{- \frac{1}{2} Γ ( t , 0 )} + α ( 0 ) \sqrt{{κ}_{e}} {\int }_{0}^{t} {dt}^{′} \sqrt{\dot{Γ} ( {t}^{′} )} {e}^{- \frac{1}{2} {κ}_{e} {t}^{′}} {e}^{\frac{1}{2} Γ ( t , {t}^{′} )} \qquad ( 5 )$$

where Γ(t, t′)=∫_{t′}^{t}dt″κᵣ(t″). The transfer efficiency of the quantum state from the first resonator device 302 to the second resonator device 304 can be defined as

$$η ≡ \sqrt{{κ}_{e}} {\int }_{0}^{t} {dt}^{′} \sqrt{\dot{Γ} ( {t}^{′} )} {e}^{- \frac{1}{2} {κ}_{e} {t}^{′}} {e}^{\frac{1}{2} Γ ( t , {t}^{′} )} . \qquad ( 6 )$$

As shown Equation (6), the quantum state transfer efficiency is a function of the linewidth of the first resonator device 302. In certain instances, although the linewidth κₑ of the first resonator device 302 is set to a constant value during a quantum state transfer process (0≤t≤t_{f}), the linewidth of the first resonator device 302 may be tuned to a different value during a different quantum state transfer process. For example, when a quantum state of the first resonator device 302 is scheduled to be transferred to a third resonator device, the linewidth of the first resonator device 302 may be tuned to an optimized value according to the properties of the third resonator device in order to maximize the quantum state transfer efficiency between the first and third resonator devices. Using the Euler-Lagrange formalism to optimize η, the corresponding Lagrangian is defined as

$$ℒ ( t , Γ , \dot{Γ} ) = \sqrt{\dot{Γ}} {e}^{- \frac{{κ}_{e} t}{2}} {e}^{- \frac{Γ}{2}} \qquad ( 7 )$$

the Lagrange equation yields the differential equation

$$\frac{d \dot{Γ}}{dt} + {κ}_{e} \dot{Γ} + {\dot{Γ}}^{2} = 0.$$

The solution of the equation yields the time profile of the linewidth of the second resonator device 304,

$${κ}_{r} ( t ) = \dot{Γ} ( t ) = \frac{{κ}_{e}}{2 {e}^{{κ}_{e} ( t - {t}_{m} )} - 1} \qquad ( 8 )$$

where κ_{r,m} is the maximum value of the linewidth of the second resonator device 304; and tₘ is a portion of the protocol time (t_{f}) during which the linewidth of the second resonator device 304 is set to its maximum value for allowing quick buildup of photons in the second resonator device 304.

$${t}_{m} = \frac{1}{{κ}_{e}} ln ( \frac{{κ}_{r , m}}{{κ}_{e} + {κ}_{r , m}} ) \qquad ( 9 )$$

Therefore, the time profile of the effective linewidth of the second resonator device 304 can be defined as

$${κ}_{r} ( t ) = \{ \begin{matrix}{κ}_{r , m} , 0 \leq t \leq {t}_{m} \\ \frac{{κ}_{e}}{2 {e}^{{κ}_{e} ( t - {t}_{m} )} - 1} , {t}_{m} < t \leq {t}_{f}\end{matrix} \qquad ( 10 )$$

During a first time period 0≤t≤tₘ, the cancellation of the back reflection does not occur until there is enough signal buildup in the second resonator device 304. The higher the maximum value of the effective linewidth of the second resonator device 304 of the receiving node is, the faster the cancellation of back reflection condition occurs and the shorter the first time period is. During a second time period tₘ<t≤t_{f}, the effective linewidth of the second resonator device 304 is decreased exponentially from its maximum value to a value approach zero.

FIG. 3B is a plot 310 showing time profiles of the linewidths of the first and second resonator devices 302, 304 during a time period (0≤t≤t_{f}) when a quantum state is transferred from the first resonator device 302 to the second resonator device 304 in FIG. 3A. As shown in FIG. 3B, the linewidth κₑ of the first resonator device 302 is set and held a constant value during the time period of 0≤t≤t_{f}; and the effective linewidth κᵣ(t) of the second resonator device 304 is tunable and varies over time. In particular, the effective linewidth κᵣ(t) of the second resonator device 304 is first set and held at a constant value κ_{r,m} during an initial time period 0≤t≤tₘ; and then exponentially reduced to a value approaching zero during a subsequent time period, e.g., tₘ<t≤t_{f}, as described in Equation (10) above. The vertical dotted line shows the time tₘ when the effective linewidth κᵣ(t) of the second resonator device 304 starts to decrease. t_{f} is the transfer protocol time.

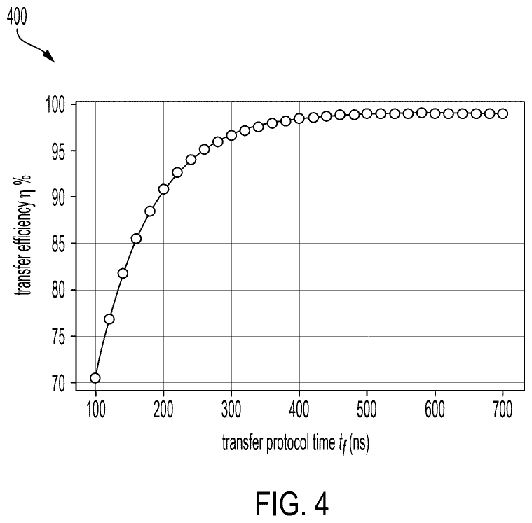

FIG. 4 is a plot 400 showing a transfer efficiency η in % as a function of transfer protocol time t_{f} in nanosecond (ns). The maximum value of the effective linewidth of the second node 304 is much greater than the linewidth of the first resonator device 302, κ_{r,m}>>κₑ. In this example, the linewidth of the first resonator device 302 is set to a constant value of 2 MHz, e.g., κₑ/2π=2 MHz; and the effective linewidth of the second resonator device 304 is set to 200 MHz, e.g., κ_{r,m}/2π=200 MHz. Assuming that there is no internal loss of the resonator devices; and the transmission line, the first and second resonator devices 302, 304 are in resonance, the transfer efficiency η of the quantum state transferring process approaches about 100% as the transfer protocol time increases.

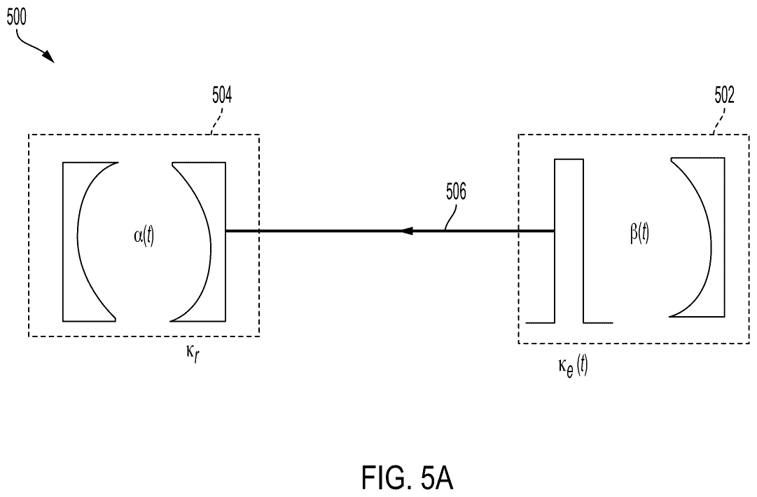

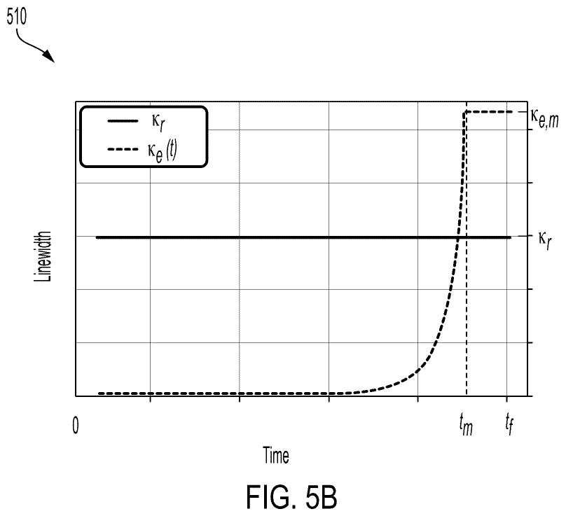

FIG. 5A is a block diagram showing aspects of an example computing network 500. The example computing network 500 includes a first resonator device 502 and a second resonator device 504 communicably coupled to the first resonator device 502 through a transmission line 506. As shown in FIG. 5A, the first resonator device 502 resides on an emitting node on which a quantum state can be created; and the second resonator device 504 resides on a remote receiving node. The quantum state can be transferred by a signal on the transmission line 506 from the first resonator device 502 to the second resonator device 504. In some implementations, the first resonator device 502 is implemented as the resonator device 203B and the tunable-frequency coupler device 208B in the second node 201B in FIG. 2; and the second resonator device 504 is implemented as the resonator device 203A of the first node 201A in FIG. 2. The computing network 500 may include additional or different features, and the components of a computing environment may operate as described with respect to FIG. 5A or in another manner.

The first resonator device 502 of the emitting node has a resonance frequency ωₑ; and the second resonator device 504 of the receiving node has a resonance frequency ωᵣ. A high quantum state transfer efficiency between the first and second resonator devices 502, 504 can be realized by cancelling the back reflection at the second resonator device 504. In some implementations, back reflection is canceled by designing time-varying linewidths of the first resonator device 502 so that the field emitted has an exponentially increasing waveform that allows destructive interference at the second resonator device 504. In some instances, during a quantum state transferring process, the second resonator device 504 of the receiving node has a linewidth at a fixed value κᵣ; and the first resonator device 502 of the emitting node has an effective linewidth that varies as a function of time, κₑ(t). When the time profile of the effective linewidth of the first resonator device 502 is configured in a certain fashion (e.g., following a pulse), a maximum value of the quantum state transfer efficiency from the first resonator device 502 to the second resonator device 504 can be achieved.

FIG. 5B is a plot 510 showing time profiles of the linewidths of the first and second resonator devices 502, 504 during a time period (0≤t≤t_{f}) when a quantum state is transferred from the first resonator device 502 to the second resonator device 504 in FIG. 5A. As shown in FIG. 5B, the linewidth κᵣ of the second resonator device 504 is set and held a constant value during the entire time period of 0≤t≤t_{f}; and the effective linewidth κₑ(t) of the first resonator device 502 is varied over time. In particular, the linewidth κₑ(t) of the first resonator device 502 is first exponentially increased form a value approaching zero to its maximum value κ_{r,m} during an initial time period 0≤t≤tₘ; and held at the maximum value κ_{r,m} during a subsequent time period, e.g., tₘ<t≤t_{f}. The vertical dotted line shows the time tₘ when the effective linewidth κₑ(t) of the first resonator device 502 is set to remain at its maximum value. t_{f} is the transfer protocol time.

FIG. 6 is a circuit diagram showing an example equivalent circuit 600 of a portion of a superconducting quantum processing circuit of a node in a computing network. The example equivalent circuit 600 represents at least a portion of the superconducting quantum processing circuit 206B of the second node 201B in FIG. 2, the second node 304 in FIG. 3A, or the first node 502 in FIG. 5A. The example equivalent circuit 600 includes a tunable-frequency coupler device 602 and a resonator device 604 communicably coupled to the tunable-frequency coupler device 602. The tunable-frequency coupler device 602 is further communicably coupled to a transmission line 608 through a buffer resonator device 606. In some implementations, the resonator device 604 is configured to receive a quantum state from a resonator device of another node through the transmission line 608; and the tunable-frequency coupler device 602 is operated to tune an effective linewidth of the resonator device 604 to a specific form for minimized back reflection and thus an optimized transfer efficiency. In some implementations, the buffer resonator device 606 allows cancellation of coupling of the resonator device 604 to the transmission line 608 especially during idling; and thus, dynamical control the coupling of the resonator device 604 to the transmission line. In certain instances, the resonator device 604 can also create and transfer a signal carrying a quantum state to a resonator device of another node through the same transmission line 608 or a different transmission line.

As shown in FIG. 6, the tunable-frequency coupler device 602 is implemented as a tunable-frequency transmon qubit device having a tunable frequency ω_{c}(t). As shown, the tunable-frequency coupler device 602 includes two Josephson junctions, e.g., a first Josephson junction 614A and a second Josephson junction 614B. The first and second Josephson junctions 614A, 614B are connected in parallel with each other to form a superconducting circuit loop 615. The tunable-frequency coupler device 602 also includes a shunt capacitor 612 with a capacitance C, which is connected in parallel with the two Josephson junctions 614A, 614B. In some instances, the shunt capacitor 612 is caused by two coupler electrodes 603A, 603B of the tunable-frequency coupler device 602.

In the example shown in FIG. 6, the two coupler electrodes 603A, 603B of the tunable-frequency coupler device 602 are capacitively coupled to the ground plane (e.g., Φ=0) through respective residual capacitors 616A, 616B having respective capacitances C_{sg} and C_{gg}. In this case, the tunable-frequency coupler device 602 is “floating”. In some instances, the tunable-frequency coupler device 602 can be grounded, in which one of the two coupler electrodes 603A, 603B is galvanically coupled to the ground plane.

The resonator device 604 and the buffer resonator device 606 include superconducting resonators operating in a microwave-frequency regime. The resonator device 604 has a resonance frequency ωₛ; and the buffer resonator device 606 has a resonance frequency ω_{b}. In the example shown in FIG. 6, each of the resonator device 604 and the buffer resonator device 606 includes a linear inductor connected between two resonator electrodes. In particular, the resonator device 604 includes a first linear inductor 626 with an inductance Lₜ connected between two resonator electrodes 622A, 622B; and the buffer resonator device 606 includes a second linear inductor 636 with an inductance Lᵣ connected between two resonator electrodes 632A, 632B.

Each of the resonator device 604 and the buffer resonator device 606 is capacitively coupled to the ground plane (e.g., Φ=0) through respective residual capacitors. In particular, the resonator device 604 is capacitively coupled to the ground plane at the two resonator electrodes 622A, 622B through residual capacitors 624A, 624B each with a capacitance 2Cₜ; and the buffer resonator device 606 is capacitively coupled to the ground plane at the two resonator electrodes 632A, 632B through residual capacitors 634A, 634B each with a capacitance 2Cᵣ.

As shown in FIG. 6, the tunable-frequency coupler device 602 is further capacitively coupled to the resonator device 604 and the buffer resonator device 606 through respective residual capacitors. In particular, the tunable-frequency coupler device 602 is capacitively coupled to the buffer resonator device 606 through residual capacitors 618A, 618B having capacitance Cᵣₛ, C_{rg}; and to the resonator device 604 through residual capacitors 620A, 620B having capacitances Cₜₛ, C_{tg}. The resonator device 604 is also capacitively coupled to the buffer resonator device 606 through a residual capacitor 638 having a capacitance Cᵣₜ. The buffer resonator device 606 is further capacitively coupled to the transmission line 608 through a residual capacitor 610 having a capacitance Cₖ.

In some implementations, control operations can be performed on the superconducting quantum processing circuit by providing control signals to the tunable-frequency coupler device 602 via a control line. The control line can receive the control signals, for example, from an external control system (e.g., the control system 204B of the node 201B in FIG. 2). In some implementations, the control line can be a conductor, an inductor, or another type of circuit component configured to carry a respective current I, which generates a respective magnetic flux Φ(t) through the superconducting circuit loop 615. For instance, the control line may include an inductor (e.g., a partial loop, a single loop, or multiple loops of a conductor) that has a mutual inductance with the superconducting circuit loop 615. In the example shown, the transition frequency of the tunable-frequency coupler device 602 is tuned by tuning a magnetic flux in the superconducting circuit loop 615. In some instances, the transition frequency of the tunable-frequency coupler device 602 may be controlled in another manner, for instance, by another type of control signal. In some implementations, the control line may include an inductance loop or another type of flux bias device that is coupled (e.g., conductively, capacitively, or inductively) to a control port to receive control signals, and to the tunable-frequency coupler device 602. In certain instances, the control signals on the control line may cause the flux bias device to generate and modulate the magnetic flux in the superconducting circuit loop 615.

In some implementations, when a quantum state is transferred on the transmission line 608 from a remote node and arrives at the buffer resonator device 606, for example after a certain time delay, the coupling between the resonator device 604 and the buffer resonator device 606 can be enabled/disabled by tuning the magnetic flux applied to the tunable-frequency coupler device 602. For example, a control signal (e.g., a DC or an AC current) can be applied to the control line to tune the magnetic flux threading to the superconducting circuit loop 615 of the tunable-frequency coupler device 602 to adjust the transition frequency of the tunable-frequency coupler device 602. When the magnetic flux on the tunable-frequency coupler device 602 is tuned between a parking value and an activating value, the coupling between the resonator device 604 and the buffer resonator device 606 can be tuned during a transfer protocol time (t_{f}) to control the time profile of the effective linewidth of the resonator device 604.

In some implementations, in order to maximize the transfer efficiency, the time profile of the effective linewidth κᵣ(t) the resonator device 604 is defined by Equation (10) when a quantum state is received by the resonator device 604.

The effective linewidth of the resonator device 604 is given by

$${κ}_{r} ( t ) = \frac{{g}^{2} ( t )}{{( \frac{{κ}_{b}}{2} )}^{2} + {( {ω}_{b} - {ω}_{s} )}^{2}} \qquad ( 11 )$$

$$where$$

$$g ( t ) = {g}_{b s} - \frac{{g}_{b c} {g}_{s c}}{2} ( \frac{1}{{ω}_{c} ( t ) - {ω}_{b}} + \frac{1}{{ω}_{c} ( t ) - {ω}_{s}} ) \qquad ( 12 )$$

where ω_{c}(t) is the frequency of the tunable-frequency coupler device 602 which can be tuned by applying magnetic flux pulse through the superconducting circuit loop 615; g(t) is a total effective coupling between the resonator device 604 and the buffer resonator device 606; ω_{b} and ωₛ are the frequencies of the buffer resonator device 606 and the resonator device 604, respectively; κ_{b} is the linewidth of the buffer resonator device 606; g_{bs} is the coupling strength between the buffer resonator device 606 and the resonator device 604; g_{bc} is the coupling strength between the buffer resonator device 606 and the tunable-frequency coupler device 602; and g_{sc} is the coupling strength between the tunable-frequency coupler device 602 and the resonator device 604.

As shown in Equation (11), the effective coupling g(t) between the resonator device 604 and the buffer resonator device 606 can be controlled by the transition frequency of the tunable-frequency coupler device 602. For example, prior to a scheduled quantum state transfer process, the effective linewidth of the resonator device 604 is set to zero, e.g., κᵣ=0. In order to set the effective linewidth of the resonator device 604 to zero, the magnetic flux pulse applied on the superconducting circuit loop 615 of the tunable-frequency coupler device 602 can be set at the parking value that satisfies the zero-coupling condition, e.g., g(t)=0.

At the beginning of a quantum state transfer process (t=0), the effective linewidth of the resonator device 604 is switched to a maximum value, e.g., κᵣ(t=0)=κ_{r,m}. For example, the magnetic flux pulse can be set to the activating value (0.5Φ₀) that enables a maximum coupling between the resonator device 604 and the buffer resonator device 606. The magnetic flux pulse is then remained at the activating value during an initial time period 0≤t≤tₘ, where tₘ is determined according to Equation (9). In some instances, value of the tₘ and t_{f} can be calculated according to the effective linewidth of the resonator device 604 and the resonator device of the emitting node, for example, by operation of the global control system 210 in FIG. 2 or in another manner.

A control schedule, at least including the time profile of the magnetic flux pulse applied on the tunable-frequency coupler device 602 can be determined by the time profile of the desired effective linewidth of the resonator device according to Equation (10). The transition frequency of the tunable-frequency coupler device 602 can be expressed as

$${ω}_{c} ( t ) = \sqrt{8 {E}_{J e f f} ( Φ ( t ) ) {E}_{C}} - {E}_{C} ( 1 + \frac{ξ}{4} ) \qquad ( 13 )$$

$${E}_{J e f f} ( Φ ) = \frac{{E}_{J}}{1 + r} \sqrt{1 + {r}^{2} + 2 r cos ( 2 π Φ ( t ) / {Φ}_{0} )}$$

where E_{Jeff}(Φ) is the effective junction energy; E_{C} is the charging energy; E_{J} is Josephson energy; r is the ratio of the junction energies of the SQUID; and ξ=\sqrt{2E_{C}/E_{Jeff}}. The magnetic flux pulse Φ(t) can be expressed as

$$Φ ( t ) = \frac{{Φ}_{0}}{2 π} {cos}^{- 1} [ \frac{1}{2 r} [ \frac{r + 1}{8 {E}_{J} {E}_{C}} ( {ω}_{b} + {E}_{C} ( 1 + \frac{9 ξ}{16} ) + \frac{{g}_{c s} {g}_{b c}}{g s b - g ( t )} ) ] ] \qquad ( 14 )$$

$$where$$

$$g ( t ) = \sqrt{{κ}_{r} ( t ) [ {( \frac{{κ}_{b}}{2} )}^{2} + {( {ω}_{b} + {ω}_{s} )}^{2} ]} . \qquad ( 15 )$$

In some implementations, in order to obtain the desired time profile of the effective linewidth of the resonator device 604 during a subsequent time period tₘ<t≤t_{f}, the control signal applied to the flux bias device and thus the magnetic flux pulse threading the superconducting circuit loop 615 can be tuned according to Equations (10), (14) and (15). The shape of the line width that would maximize the transfer efficiency is controlled by the flux pulse sent to the tunable-frequency coupler device 602. The signal emitted by the emitting resonator device follows the emitting resonator linewidth profile (e.g., remain constant during the transfer protocol time (t_{f})).

After the quantum state transferring process t>t_{f}, the magnetic flux pulse is returned back to the parking value where the effective coupling strength between the resonator device 604 and the buffer resonator device 606 vanishes, e.g., becomes equal to zero, or less than or equal to a predetermined threshold value; and the effective linewidth of the resonator device 604 also vanishes, e.g., becomes equal to zero, or less than or equal to a predetermined threshold value. In some implementations, the control schedule further includes control schedules for other devices. For example, when the resonator device and the buffer resonator device are implemented as tunable-frequency qubit devices as shown in FIGS. 9A-9C, 10, and 11, the control schedule includes control signals that are applied on the resonator device and the buffer resonator device.

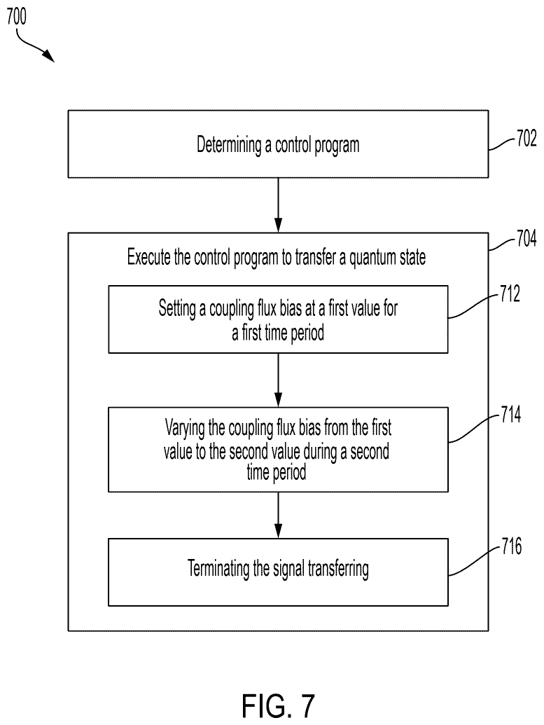

FIG. 7 is a flow chart showing aspects of an example process 700. The example process 700 can be performed by operations of the first and second nodes 201A/201B and global controller system 210 in the computing network 200. In some instances, the example process 700 can also be performed by operating a node with a superconducting quantum processing circuit represented by the equivalent circuit 600, 900, 940, 960, 1100 as shown in FIGS. 6, 9A-9C, 10, or a node represented by another equivalent circuit. The example process 700 may include additional or different operations, including operations performed by additional or different components, and the operations may be performed in the order shown or in another order.

One or more operations in the example process 700 can be controlled by classical computing resources (e.g., a microprocessor or other data processing apparatus) operating on the global controller system (e.g., the global controller system 210 in FIG. 2). Classical computing resources of the node (e.g., the control system 204B of the node 201B in FIG. 2) as well as the quantum computing resources (e.g., the superconducting quantum processing circuit 206B of the node 201B in FIG. 2) can be operated to execute one or more operations of the example process 700.

At 702, a control schedule is determined. The control schedule includes a series of control operations which are scheduled to be performed on various quantum circuit devices of the superconducting quantum processing circuit of the first node when a quantum state is received by the first node from the second node or transmitted by the first node to the second node. In some implementations, the series of control operations in the control schedule includes control operations that are specifically applied onto a tunable-frequency coupler device of the first node (e.g., the tunable-frequency coupler device 602, 902, 942, 962, 1002 in FIGS. 6, 9A-9C, 10) for tuning the effective linewidth of a resonator device (e.g., the resonator device 604 in FIG. 6 or the tunable-frequency qubit devices 904, 944, 964, 1004 in FIGS. 9A-9C, 10) capacitively coupled to the tunable-frequency coupler device. For example, when the tunable-frequency coupler device is implemented as the tunable-frequency coupler device 602, the control schedule includes control signals generated by the control system and delivered via the control lines associated with the tunable-frequency coupler device and relative timings of the control signals (e.g., the tₘ defined in Equation (9)). The control schedule is executed to generate a time-profile of a magnetic flux pulse on the superconducting circuit loop (e.g., the superconducting circuit loop 615, 919, 1015 in FIGS. 6, 9A-9C, 10) of the tunable-frequency coupler device.

In some implementations, the control schedule further includes control signals that delivered to other quantum circuit devices of the superconducting quantum processing circuits via associated control lines. For example, when the resonator device of the node is a tunable-frequency qubit device (e.g., the tunable-frequency qubit device 904, 944, 964, 1004 as shown in FIGS. 9A-9C and 10), the control schedule may include flux bias signals applied on the tunable-frequency qubit device to tune its transition frequency. For another example, when the tunable-frequency coupler device is communicably coupled to the transmission line through a buffer resonator device and the buffer resonator device is a tunable-frequency qubit device (e.g., the second tunable-frequency qubit device 906 as shown in FIG. 9A), the control schedule may further include flux bias signals applied on the buffer resonator device to tune its transition frequency such that it is in resonance with the resonator device (e.g., the first tunable-frequency qubit device 904 as shown in FIG. 9A) when a quantum state is transferred to the first node or from the first node. For another example, when the superconducting quantum processing circuit of the second node also includes tunable-frequency coupler devices or tunable-frequency qubit devices, a control schedule for operating the second node may also include respective control signals to respective quantum circuit devices to tune transition frequencies, coupling, effective linewidth, or other properties of the quantum circuit devices.

In some implementations, the control schedule is determined by operation of the control system according to a desired time profile of an effective linewidth of the resonator device of the first node. Prior to the determination of the control schedule, the desired time profile of the effective linewidth of the resonator device in the first node is determined. For example, the desired time profile of the effective linewidth of the resonator device in the first node can be determined by operation of a global control system (e.g., the global control system 210) according to device parameters received from the first and the second nodes. In some implementations, the device parameters that are used to determine the desired time profile of the effective linewidth of the resonator device of the first node include resonance frequencies of the buffer resonator device and the resonator device of the first node, the frequency range of the tunable-frequency coupler device, a linewidth of the resonator device of the second node, coupling strength between the resonator device and the tunable-frequency coupler device, coupling strength between the buffer resonator device and the tunable-frequency coupler device, coupling strength between the buffer resonator device and the resonator device, a Josephson junction energy of the tunable-frequency coupler device, and other device and circuit parameters of the first and second nodes, for example, according to Equations 9, 10, and 13-15.

In some implementations, the control schedules to be operated on the first and second nodes are coordinated and synchronized by the global controller system communicably coupled to the respective control systems of the first and second nodes. For example, when a quantum state transfer process is to be scheduled between the first and second nodes, a time delay in transferring a signal on the superconducting transmission line carrying a quantum state from the second node to the first node can be obtained or determined by the global controller system according to the properties of the transmission line (e.g., length, etc.). Information including the starting time of the quantum state transfer process, the time delay of the signal, and other synchronization information may be transmitted from the global controller system to the control systems of the first and second nodes. In some implementations, the information is further used to determine the relative timing of the control operations in the control schedules when being executed on the first and second nodes.

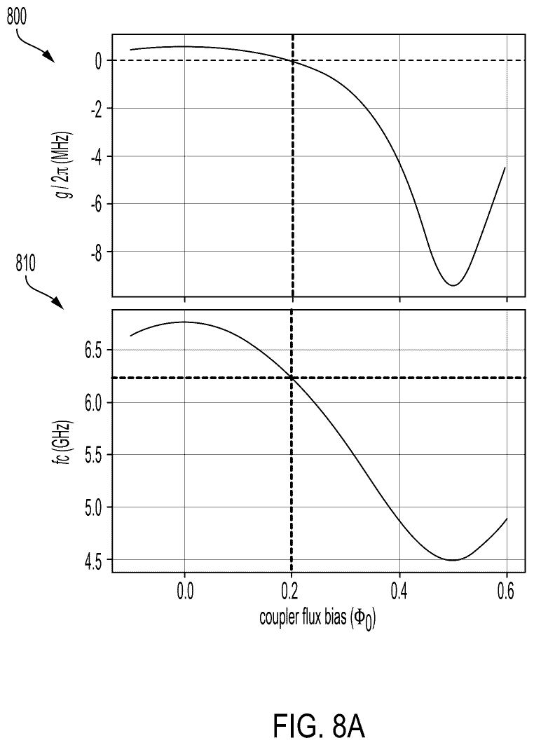

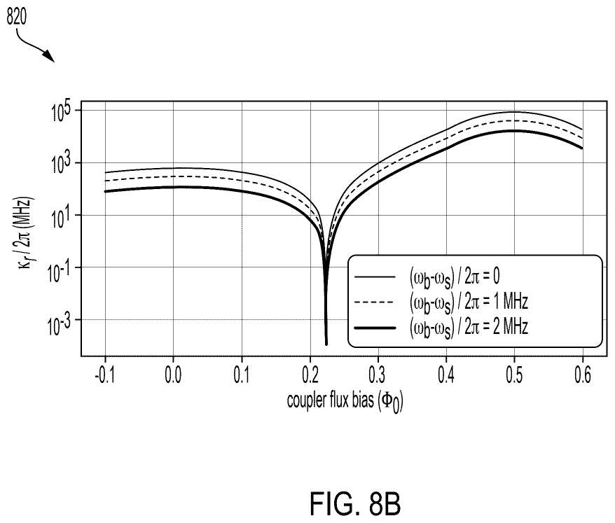

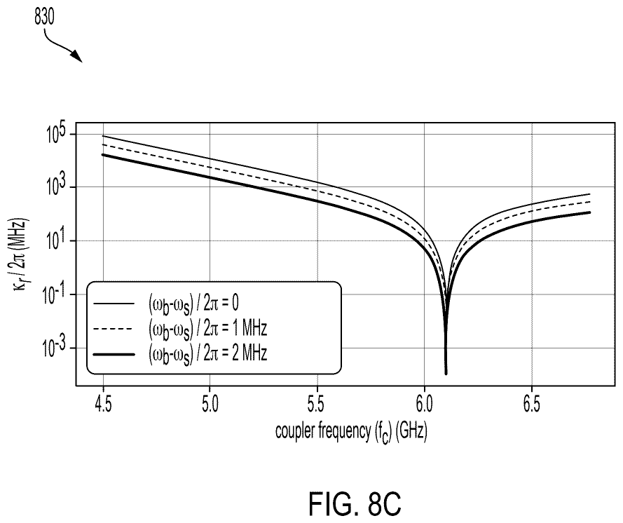

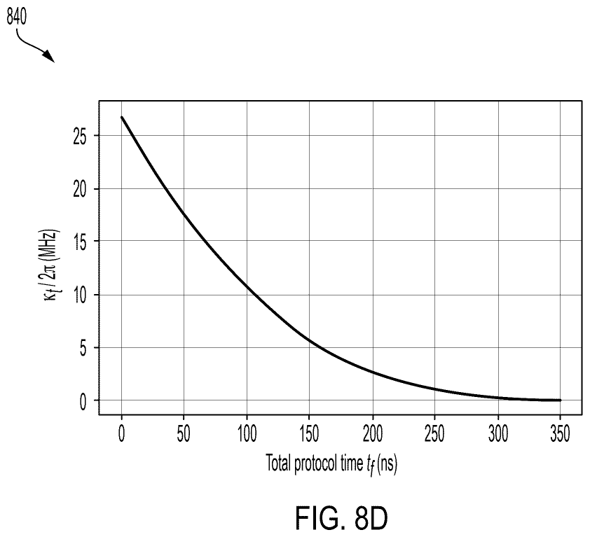

FIG. 8A includes a plot 800 showing an effective coupling in MHz between the buffer resonator device and the resonator device and a plot 810 showing the transition frequency of the tunable-frequency coupler device in the first node as a function of the magnetic flux pulse in flux quantum (Φ₀) applied on the superconducting circuit loop of the tunable-frequency coupler device. The coupling strength between the buffer resonator device and the resonator device is g₁₂/2π=6.5 MHz; the product of the coupling strength between the buffer resonator device and the tunable-frequency coupler device and the coupling strength between the resonator device and the tunable-frequency coupler device g_{1c}g_{2c}/(4π)²=8.5 MHz\hat{ }2; the transition frequency of the tunable-frequency coupler device is in a range of 6778 MHz and 4749 MHz; the resonance frequency of the resonator device is

$$\frac{{ω}_{s}}{2 π} = 3900 MHz ;$$

and anharmonicity of the tunable-frequency coupler device at zero flux bias

$$\frac{{η}_{max}}{2 π} = 120 MHz$$

and the κ_{b,m}/2π=2 MHz is the linewidth of the buffer resonator device

In some implementations, the device parameters received from the first node include a parking value and an activation value of the magnetic flux pulse. The parking value and the activating value of the magnetic flux pulse are determined by operation of the control system of the first node. The activating value (e.g., about 0.5Φ₀ as shown in the plots 800, 810 of FIG. 8A) of the magnetic flux pulse is a value of the magnetic flux pulse when applied on the tunable-frequency coupler device causes the effective coupling between the buffer resonator device and the resonator device reaching its maximum value or above a first threshold value; and the parking value (e.g., about 0.2Φ₀ as shown in the plots 800, 810 of FIG. 8A) of the magnetic flux pulse is a value of the magnetic flux pulse when applied on the tunable-frequency coupler device causes the coupling between the buffer resonator device and the resonator device vanish or below a second threshold value.

In some instances, the device parameters of the quantum circuit devices in the superconducting quantum processing circuits of the first and second nodes between which a signal carring a quantum state is transferred are obtained by the global controller system from the first and second nodes. In some implementations, the device parameters of the tunable-frequency qubit devices, the tunable-frequency coupler devices, the resonator devcies, the buffer resonator devices, and other quantum circuit devices in the superconducting quantum processing circuits are determined by performing a measurement or characterization process, a tune-up process, or another type of calibratoin process. In some instances, a measurement process can characterize a particular set of quantum circuit devices in the quantum processing unit for performing the organized quantum program. In some instances, the device parameters may be predetermined using another process, which then can be stored and obtained in another manner. For example, a measurement process can be executed to characterize all the quantum circuit devices in a quantum processing unit to obtain the device parameters of each of the qubit devices and coupler devices in a device array, for example, once a quantum processor is cooled down.

In some instances, device parameters that can be used to characterize a tunable-frequency qubit device include a tunable range of the transition frequency. In certain examples, a tunable range of the transition frequency is defined by a maximal frequency value, e.g., the |0 [symbol] →|1 [symbol] transition frequency value at a magnetic flux pulse of zero flux quantum applied to the tunable-frequency coupler device,

$${ω}_{01} ( Φ = 0 ) ≡ {ω}_{01}^{max} \qquad ( 16 )$$

and a minimum frequency value, e.g., the |0 [symbol] →|1 [symbol] transition frequency value at a magnetic flux pulse of half-flux quantum,

$${ω}_{01} ( Φ = 0.5 {Φ}_{0} ) ≡ {ω}_{01}^{min} \qquad ( 17 )$$

anharmonicity at the magnetic flux pulse of zero flux quantum,

$$η ( Φ = 0 ) ≡ {η}^{max} \qquad ( 18 )$$

and the magnetic flux pulse Φ, e.g.,

$$Q = Q ( {ω}_{01}^{max} , {ω}_{01}^{min} , {η}^{max} , Φ ) \qquad ( 19 )$$

where Q represents a collection of device parameters that can be used to describe a qubit device. In some implementations, a maximal frequency value may be at a different magnetic flux pulse. For example, a maximal frequency value may be at a value offset from a magnetic flux pulse of zero flux quantum, a magnetic flux of half flux quantum, or another value. In some instances, device parameters further include periodicity, coupling strengths, and other device parameters can be calibrated, measured, and stored, e.g., in a database of the memory 112 of the server 108. In certain instances, circuit parameters of circuit components in an equivalent circuit representing quantum circuit devices in the quantum processing unit can be calculated based on the device parameters.

In some examples, the transition frequency of a tunable-frequency qubit device or a tunable-frequency coupler device from the ground state |0 [symbol] to the first excited state |1 [symbol] is measured by using qubit spectroscopy. Ramsey interferometry can then be used to fine tune the value of the transition frequency obtained from the spectroscopic measurement. In some instances, the transition frequency can be measured at one or more reference values of the applied magnetic flux bias. For example, the transition frequencies of tunable-frequency qubit/coupler devices can be measured at zero and one-half flux quantum; the tunable-frequency qubit/coupler devices may be measured under other flux conditions.

In some examples, after the transition frequencies of the tunable-frequency qubit/coupler devices are obtained, qubit spectroscopy can be used to measure the transition frequency from the ground state |0 [symbol] to the second excited state |2 [symbol] which can be used to calculate the anharmonicity of the tunable-frequency qubit/coupler devices. For instance, the absolute value of the anharmonicity of tunable-frequency qubit/coupler devices may be computed as |η|=|2ω₀₁ −ω₀₂], where ω₀₁ represents the transition frequency from the ground state |0 [symbol] to the first excited state |1 [symbol] of the tunable-frequency qubit/coupler device, and ω₀₂ represents the transition frequency from the ground state |0 [symbol] to the second excited state |2 [symbol] of the tunable-frequency qubit/coupler devices.

Control signals (e.g., a flux bias signal, a flux modulation signal, a qubit drive signal or another type of control signal) in the control schedule can be characterized by control parameters of the control signals including modulation parameters such as a DC flux bias Φ_{dc}, a flux modulation amplitude Φ_{ac}, a flux modulation frequency fₘ, a modulation phase θₘ, and drive parameters, such as a drive amplitude Ω_{d}, a drive frequency f_{d}, and a drive phase θ_{d}. In certain examples, the device parameters obtained from the device measurement process can be used to determine initial values of the control parameters of the control signals that can be applied to the respective quantum circuit devices, e.g., to activate a coupling between two qubit devices by tuning the magnetic flux pulse from the parking value to the activating value, to deactivate a coupling between two qubit devices by tuning the magnetic flux pulse from the activating value to the parking value, to bring two resonator devices into resonance for a precise time period and to obtain a specific time profile of the effective linewidth of the resonator device, and to perform other functions.

In some implementations, the control parameters include pulse parameters of the magnetic flux pulse applied to the superconducting circuit loop of the tunable-frequency circuit device. The pulse parameters of the magnetic flux pulse are selected and determined for maximizing the transfer efficiency of transferring the quantum state from the second node to the resonator device of the first node. In some instances, the pulse parameters of the magnetic flux pulse are determined according to the desired time profile of the effective linewidth of the resonator device. For example, the pulse parameters define a time profile of the magnetic flux pulse. In some implementations, the pulse parameters include a shape of the magnetic flux pulse, an amplitude of the magnetic flux pulse, a duration of the magnetic flux pulse, and other pulse parameters.

At 704, the control schedule is executed while a signal carrying a quantum state is transmitted. In some instances, the signal carrying a quantum state may be transmitted from the second node to the first node or from the first node to the second node. The signal can be transmitted on the transmission line communicably coupled between the first and second nodes. In some implementations, the control schedule is executed by operation of the control system of the first node to obtain a tunable effective linewidth over a time period. In some implementations, a control schedule can be also executed by operation of the control system of the second node to maintain a constant effective linewidth of the resoantor device during the same time period. In some implementations, a flux bias control signal is generated by operation of the control system of the first node according to pulse parameters of the magnetic flux pulse; and delivered to a flux bias control line associated with the tunable-frequency coupler device of the first node. In some implementations, the operation 704 includes sub-operations 712, 714, and 716.

At 712, the magnetic flux pulse applied to the superconducting circuit loop of the tunable-frequency coupler device is set at a first value for a first time period according to the control schedule. In some implementations, when the signal is transmitted from the second node (e.g., the emitting node) to the first node (e.g., the receiving node), the first value is the activating value of the magnetic flux pulse. In this case, the magnetic flux pulse applied to the superconducting circuit loop of the tunable-frequency coupler device of the first node is set to the activating value at the time when the signal carrying a quantum state is received at the first node, e.g., at the buffer resonator device 606 from the transmission line 608. In some instances, prior to receiving the signal on the transmission line, the magnetic flux pulse applied on the tunable-frequency coupler device of the first node is maintained at the parking value. When the signal carrying a quantum state is received at the first node, the magnetic flux pulse can be switched from the parking value to the activating value. The magnetic flux pulse is then maintained at the activating value during a first time period (0≤t≤tₘ) such that the effective linewidth of the resonator device capacitively coupled to the tunable-frequency coupler device is maintained at its maximum value or a value above a first threshold value. In other words, the resonator device is activated (e.g., at the maximum coupling) for receiving the signal during the first time period.

FIG. 8B is a plot 820 showing the effective linewidth in MHz of the resonator device of the first node as a function of the magnetic flux pulse in flux quantum (Φ₀) applied on the tunable-frequency coupler device at different frequency offsets. A frequency offset represents a detuning between the resonator device and the buffer resonator device, e.g., ω_{b}−ωₛ. Detuning between the two resonator devices in the first and second nodes has impact on the effective linewidth of the resonator device of the first node in response to the magnetic flux pulse.

At 714, the magnetic flux pulse is varied at an exponential rate from the first value to the second value during a second time period according to the control schedule. In some implementations, when the signal is received by the first node, the magnetic flux pulse of the tunable-frequency coupler device is varied from the maximum value to a value approaching zero flux during the second time period (tₘ<t≤t_{f}). In other words, the resonator device is slowly deactivated (e.g., from the maximum coupling to zero coupling) when the signal continues to be received at the first node during the second time period.

At 716, the signal transferring process is terminated. At the end of the second time period (t_{f}), the magnetic flux pulse is set to the parking value where the effective coupling between the buffer resonator device and the resonator device is deactivated or vanishes, and the effective linewidth of the resonator device is set at its minimum value or a value less than a second threshold value.

FIG. 8C is a plot 830 showing the effective linewidth in MHz of the resonator device of the first node as a function of the transition frequency in GHz of the tunable-frequency coupler device at different frequency offsets. Detuning between the resonator device and the buffer resonator device of the first node, e.g., ω_{b}−ωₛ. has impact on the effective linewidth of the resonator device of the first node in response to the transition frequency of the tunable-frequency coupler device.

In some implementations, the magnetic flux pulse Φ(t) that yields an exponential decreasing function for linewidth is defined by

$$Φ ( t ) = {Φ}_{d c} + {Φ}_{a c} ( 1 - {e}^{t / τ} ) \qquad ( 20 )$$

wherein ω_{dc} is the amplitude of the dc flux bias; Φ_{ac} is the amplitude of the fast flux pulse; and τ is the time constant determined by the protocol time.

FIG. 8D is a plot 840 showing the effective linewidth in MHz of the resonator device of the first node as a function of the total protocol time (t_{f}) in ns. The total protocol time t_{f} is about 350 ns in this case.

In some instances, the control schedule may be updated when changes are made to a superconducting quantum processing circuit of the first or the second nodes. For example, a calibration process may identify changes in device parameters which can be used to update the control parameters of the control signals and the relative timings. In some instances, when different quantum circuit devices of the second node (e.g., a different resonator device and a different tunable-frequency coupler device) are selected for receiving the quantum state in the signal transmitted from the same resonator device in the second node, an updated control schedule may be generated and executed on respective quantum circuit devices.

In some cases, the sub-operations 712, 714, 716 (and possibly other operations) within the operation 704 are executed as an iterative process, where each iteration includes an execution of the control schedule to receive a quantum state by the first node from the second node. Each iteration of the iterative process may include additional operations and parameter evaluations. In some cases, sub-steps 712, 714 with the operation 704 may be executed in a different order. For example, when the first node is a transmitting node and the second node is a receiving node, the magnetic flux pulse can be varied from the first value to the second value during the first time period and kept at the second value during the second time period. In this case, the first value is the parking value; and the second value is the activating value of the magnetic flux pulse applied on the superconducting circuit loop of the tunable-frequency coupler device.

FIG. 9A is a circuit diagram showing an example equivalent circuit 900 of a portion of an example superconducting quantum processing circuit of a node in a computing network. The example equivalent circuit 900 represents at least a portion of the superconducting quantum processing circuit 206B of the second node 201B in FIG. 2, the second node 304 in FIG. 3A, or the first node 502 in FIG. 5A. The example equivalent circuit 900 represented in FIG. 9A includes a first tunable-frequency qubit device 904, a second tunable-frequency qubit device 906, and a tunable-frequency coupler device 902. The tunable-frequency coupler device 902 is capacitively coupled between the first and second tunable-frequency qubit device 904, 906. The second tunable-frequency qubit device 906 is further communicably coupled to a transmission line 908. The first tunable-frequency qubit device 904 is configured to receive a quantum state from a resonator device of another node (e.g., the resonator device 203A of the first node 201A in FIG. 2, the first resonator device 302 in FIG. 3A and the first resonator device 502 in FIG. 5A) through the transmission line 908; and the tunable-frequency coupler device 902 is operated to tune the coupling between the first and second tunable-frequency qubit devices 904, 906 and an effective linewidth of the first tunable-frequency qubit device 904 to a specific form for minimized back reflection and thus a maximized transfer efficiency. The first tunable-frequency qubit device 904 can be implemented as the resonator device 203B in FIG. 2 or in another manner; and the tunable-frequency coupler device 902 may be implemented as the tunable-frequency coupler device 208B, 602 in FIGS. 2, 6 or in another manner. In some implementations, the transmission line 908 can be implemented as the transmission line 202, 306, 506 in FIGS. 2, 3A, 5A or in another manner.

In the example shown in FIG. 9A, each of the first and second tunable-frequency qubit devices 904, 906 and the tunable-frequency coupler device 902 is implemented as a tunable-frequency transmon qubit device. As shown, the first tunable-frequency qubit device 904 includes two Josephson junctions, e.g., a first Josephson junction 914A and a second Josephson junction 914B. The first and second Josephson junctions 914A, 914B are connected in parallel with each other to form a first superconducting circuit loop 915. The first tunable-frequency qubit device 904 also includes a shunt capacitor 912, which is connected in parallel with the two Josephson junctions 914A, 914B. The shunt capacitor 912 may be caused by two qubit electrodes of the first tunable-frequency qubit device 904.

The second tunable-frequency qubit device 904 includes two Josephson junctions, e.g., a third Josephson junction 924A and a fourth Josephson junction 924B. The third and fourth Josephson junctions 924A, 924B are connected in parallel with each other to form a second superconducting circuit loop 925. The second tunable-frequency qubit device 906 also includes a shunt capacitor 922, which is connected in parallel with the two Josephson junctions 924A, 924B. The shunt capacitor 922 may be caused by two qubit electrodes of the second tunable-frequency qubit device 906.

The tunable-frequency coupler device 902 includes two Josephson junctions, e.g., a fifth Josephson junction 918A and a sixth Josephson junction 918B. The fifth and sixth Josephson junctions 918A, 918B are connected in parallel with each other to form a third superconducting circuit loop 919. The tunable-frequency coupler device 902 also includes a shunt capacitor 916, which is connected in parallel with the two Josephson junctions 918A, 918B. The shunt capacitor 916 is caused by two electrodes of the tunable-frequency coupler device 902.

In the example shown in FIG. 9A, each of the first and second tunable-frequency qubit devices 904, 906 and the tunable-frequency coupler device 902 is capacitively coupled to the ground plane (e.g., Φ=0) through respective residual capacitors. Particularly, the first tunable-frequency qubit device 904 is coupled to the ground plane via residual capacitors 926A, 926B; the second tunable-frequency qubit device 906 is coupled to the ground plane via residual capacitors 928A, 928B; and the tunable-frequency coupler device 902 is coupled to the ground plane via residual capacitors 930A, 930B. In the example shown in FIG. 9A, each of the tunable-frequency qubit devices 904, 906 and the tunable-frequency coupler device 902 is floating. In some instances, each of the tunable-frequency qubit devices 904, 906 and the tunable-frequency coupler device 902 may be grounded, in which situation, one of the qubit electrodes or one of the coupler electrodes is galvanically connected to the ground plane.

As shown in FIG. 9A, the tunable-frequency coupler device 902 is capacitively coupled to each of the first and second tunable-frequency qubit devices 904, 906 via respective residual capacitors. Particularly, the tunable-frequency coupler device 902 is coupled to the first tunable-frequency qubit device 904 via residual capacitors 932A, 932B; and the tunable-frequency coupler device 902 is coupled to the second tunable-frequency qubit device 906 via residual capacitors 934A, 934B. The residual capacitor 932A/932B and 934A/934B represent the indirect capacitive coupling component between the first and second tunable-frequency qubit devices 904, 906. Further, the first and second tunable-frequency qubit devices 904, 906 are also capacitively coupled to each other via a residual capacitor 936. Therefore, the residual capacitor 936 represents the direct capacitive coupling component between the first and second tunable-frequency qubit devices 904, 906.

In some implementations, control operations can be performed on the superconducting quantum processing circuit by providing control signals defined by control parameters via associated control lines to the first and second tunable-frequency qubit devices 904, 906 and the tunable-frequency coupler device 902. The control lines can receive the control signals, for example, from an external control system associated with the node. In some implementations, each of the control lines can be a conductor, an inductor, or another type of circuit component configured to carry a respective current I, which generates a respective magnetic flux Φ(t) through the superconducting circuit loops 915, 919, 925. For instance, the control line may include an inductor (e.g., a partial loop, a single loop, or multiple loops of a conductor) that has a mutual inductance with the superconducting circuit loop 915, 919, 925. In the example shown, the transition frequency of the first tunable-frequency qubit device 904 is tuned by tuning a first magnetic flux in the first superconducting circuit loop 915; the transition frequency of the second tunable-frequency qubit device 906 is tuned by tuning a second magnetic flux in the second superconducting circuit loop 925; and the transition frequency of the tunable-frequency coupler device 902 is tuned by tuning a third magnetic flux in the third superconducting circuit loop 919. In some instances, the transition frequencies may be controlled in another manner, for instance, by another type of control signal. In some implementations, the control lines may include an inductance loop or another type of flux bias device that is coupled (e.g., conductively, capacitively, or inductively) to a control port to receive control signals, and to the first or second tunable-frequency qubit device 904, 906. In certain instances, the control signals on the control lines may cause the flux bias device to generate and modulate the magnetic flux in the superconducting circuit loop 915, 925.

In some implementations, when the two tunable-frequency qubit devices 904, 906 are coupled through the tunable-frequency coupler device 902, the coupling between the two tunable-frequency qubit devices 904,906 can be enabled/disabled by tuning a magnetic flux pulse applied to the superconducting circuit loop 919 of the tunable-frequency coupler device 902. For example, a separate control signal (e.g., a DC or an AC current) can be applied to a control line (e.g., a flux bias control line) to tune the magnetic flux threading to the third superconducting circuit loop 919 of the tunable-frequency coupler device 902 to adjust the transition frequency of the tunable-frequency coupler device 902. When the magnetic flux applied to the tunable-frequency coupler device 902 is at a parking value, the coupling between the two tunable-frequency qubit devices 904, 906 can be turned off or deactivated. When the magnetic flux on the tunable-frequency coupler device 902 is at an activating value, the coupling between the two tunable-frequency qubit device 904, 906 can be activated. In another instance, operation for determining the parking value and the activating value of the magnetic flux on the tunable-frequency coupler device 902 may be determined by performing a calibration process.

When the magnetic flux applied to the tunable-frequency coupler device 902 is tuned from the activating value to the parking value following a specific time profile, the effective linewidth of the first tunable-frequency qubit device 904 can be tuned for optimized transfer performance (e.g., maximized transfer efficiency). In some instances, a quantum state can be transferred at a maximized transfer efficiency from or to the node with the equivalent circuit 900 shown in FIG. 9A by performing operations in the example process 700 in FIG. 7 or in another manner. In some implementations, the magnetic flux is a magnetic flux pulse which is defined by pulse parameters including a shape, an amplitude, and a duration.

FIG. 9B is a circuit diagram showing an example equivalent circuit 940 of a portion of an example superconducting quantum processing circuit of a node in a computing network. The example equivalent circuit 940 represents at least a portion of the superconducting quantum processing circuit 206B of the second node 201B in FIG. 2, the second node 304 in FIG. 3A, or the first node 502 in FIG. 5A. The example equivalent circuit 940 represented in FIG. 9B includes a tunable-frequency coupler device 942, a tunable-frequency qubit device 944, and a buffer resonator device 946. The tunable-frequency coupler device 942 is capacitively coupled between the tunable-frequency qubit device 944 and the buffer resonator device 946. The buffer resonator device 946 is further communicably coupled to a transmission line 948. The tunable-frequency qubit device 944 is configured to receive a quantum state from a resonator device of another node through the transmission line 948; and the tunable-frequency coupler device 942 is operated to tune the coupling between the tunable-frequency qubit devices 944 and the buffer resonator device 946 and an effective linewidth of the tunable-frequency qubit device 944 to a specific form for minimized back reflection and thus a maximized transfer efficiency. The tunable-frequency qubit device 944 can be implemented as the first tunable-frequency qubit device 904 in FIG. 9A, the resonator device 203B in FIG. 2, or in another manner; the tunable-frequency coupler device 942 may be implemented as the tunable-frequency coupler device 208B, 602, 902 in FIGS. 2, 6, 9A, or in another manner; the buffer resonator device 946 may be implemented as the buffer resonator device 606 in FIG. 6 or in another manner; and the transmission line 948 may be implemented as the transmission line 908 in FIG. 9A or in another manner.

FIG. 9C is a circuit diagram showing an example equivalent circuit 960 of a portion of an example superconducting quantum processing circuit of a node in a computing network. The example equivalent circuit 960 represents at least a portion of the superconducting quantum processing circuit 206B of the second node 201B in FIG. 2, the second node 304 in FIG. 3A, or the first node 502 in FIG. 5A. The example equivalent circuit 960 represented in FIG. 9C includes a tunable-frequency coupler device 962, a tunable-frequency qubit device 964, and a buffer resonator device 966. The tunable-frequency coupler device 962 is capacitively coupled between the tunable-frequency qubit device 964 and the buffer resonator device 966. The buffer resonator device 966 is further communicably coupled to a transmission line 968. The tunable-frequency qubit device 964 is configured to receive a quantum state from a resonator device of another node through the transmission line 968; and the tunable-frequency coupler device 962 is operated to tune the coupling between the tunable-frequency qubit devices 964 and the buffer resonator device 966 and an effective linewidth of the tunable-frequency qubit device 964 to a specific form for minimized back reflection and thus an optimized transfer efficiency. The tunable-frequency qubit device 964 can be implemented as the first tunable-frequency qubit device 904 in FIG. 9A, the resonator device 203B in FIG. 2, or in another manner; the tunable-frequency coupler device 962 may be implemented as the tunable-frequency coupler device 208B, 602, 902, 942 in FIGS. 2, 6, 9A, 9B, or in another manner; the buffer resonator device 966 may be implemented as the buffer resonator device 606, 906 in FIG. 6, 9B, or in another manner; and the transmission line 968 may be implemented as the transmission line 908 in FIG. 9A or in another manner.

The example equivalent circuit 960 represented in FIG. 9C further includes a readout resonator device 980, which is capacitively coupled to the tunable-frequency qubit device through residual capacitors 986A, 986B. The readout resonator device 980 is controlled to readout a quantum state of the tunable-frequency qubit device 964. The readout resonator device 980 includes a linear inductor 982 connected between two electrodes capacitively coupled to the ground plane through residual capacitors 984A, 984B.

FIG. 10 is a circuit diagram showing an example equivalent circuit 1000 of a portion of an example superconducting quantum processing circuit of a node in a computing network. The example equivalent circuit 1000 represents at least a portion of the superconducting quantum processing circuit 206B of the second node 201B in FIG. 2, the second node 304 in FIG. 3A, or the first node 502 in FIG. 5A. The example equivalent circuit 1000 represented in FIG. 10 includes a tunable-frequency coupler device 1002 and a tunable-frequency qubit device 1004. The tunable-frequency coupler device 1002 is capacitively coupled to the tunable-frequency qubit device 1004. The tunable-frequency coupler device 1002 and the tunable-frequency qubit device 1004 are further communicably coupled to a transmission line 1006. The tunable-frequency qubit device 1004 is configured to receive a quantum state from a resonator device of another node through the transmission line 1006; and the tunable-frequency coupler device 1002 is operated to tune an effective linewidth of the tunable-frequency qubit device 1004 to a specific form for minimized back reflection and thus a maximized transfer efficiency. The tunable-frequency qubit device 1004 can be implemented as the resonator device 203B, 904, 944, 964 in FIGS. 2, 9A-9C, or in another manner; and the tunable-frequency coupler device 1002 may be implemented as the tunable-frequency coupler device 208B, 602, 902, 942, 962 in FIGS. 2, 6, 9A-9C, or in another manner; and the transmission line 1006 may be implemented as the transmission line 908 in FIG. 9A or in another manner.

In the example shown in FIG. 10, each of the tunable-frequency qubit device 1004 and the tunable-frequency coupler device 1002 is implemented as a tunable-frequency transmon qubit device. As shown, the tunable-frequency qubit device 1004 includes two Josephson junctions, e.g., a first Josephson junction 1016A and a second Josephson junction 1016B. The first and second Josephson junctions 1016A, 1016B are connected in parallel with each other to form a first superconducting circuit loop 1019. The tunable-frequency qubit device 1004 also includes a shunt capacitor 1018 with a capacitance C₁, which is connected in parallel with the two Josephson junctions 1016A, 1016B. The shunt capacitor 1018 may be caused by two qubit electrodes of the tunable-frequency qubit device 1004.

The tunable-frequency coupler device 1002 includes two Josephson junctions, e.g., a third Josephson junction 1012A and a fourth Josephson junction 1012B. The third and fourth Josephson junctions 1012A, 1012B are connected in parallel with each other to form a second superconducting circuit loop 1015. The tunable-frequency coupler device 1002 also includes a shunt capacitor 1014 with a capacitance C₀, which is connected in parallel with the two Josephson junctions 1012A, 1012B. The shunt capacitor 1014 is caused by two coupler electrodes of the tunable-frequency coupler device 1002.

In the example shown in FIG. 10, each of the tunable-frequency qubit device 1004 and the tunable-frequency coupler device 1002 is capacitively coupled to the ground plane (e.g., Φ=0) through respective residual capacitors. Particularly, the tunable-frequency qubit device 1004 is coupled to the ground plane via residual capacitors 1024A, 1024B with capacitances C₀ₛ, C_{0g}; and the tunable-frequency coupler device 1002 is coupled to the ground plane via residual capacitors 1022A, 1022B with capacitances C₁ₛ, C_{1g}. In the example shown in FIG. 10, each of the tunable-frequency qubit device 1004 and the tunable-frequency coupler device 1002 is floating. In some instances, each of the tunable-frequency qubit device 1004 and the tunable-frequency coupler device 1002 may be grounded, in which situation, one of the qubit electrodes or one of the coupler electrodes is galvanically connected to the ground plane.

As shown in FIG. 10, the tunable-frequency coupler device 1002 is capacitively coupled to each of the tunable-frequency qubit device 1004 via a residual capacitor 1010 with a capacitance C₀₁. Each of the tunable-frequency coupler device 1002 and the tunable-frequency qubit device 1004 is capacitively coupled to the transmission line 1006 through respective residual capacitors 1008A, 1008B with capacitance C₀ₑ, C₁ₑ. The transmission line is represented by an external resistor Z₀.

The equivalent circuit 1000 in FIG. 10 can be represented by the capacitance (C), conductance (G), and inverse inductance matrices (K) (considering junctions to be linearized inductors to lowest order),

$$C = ( \begin{matrix}{C}_{0 Σ} & - {C}_{0} & - {C}_{01} & 0 & - {C}_{0 e} \\ - {C}_{0} & {C}_{0} + {C}_{0 g} & 0 & 0 & 0 \\ - {C}_{01} & 0 & {C}_{1 Σ} & - {C}_{1} & - {C}_{1 e} \\ 0 & 0 & - {C}_{1} & {C}_{1} + {C}_{1 g} & 0 \\ - {C}_{0 e} & 0 & - {C}_{1 e} & 0 & {C}_{0 e} + {C}_{1 e}\end{matrix} ) \qquad ( 21 )$$

$${G}_{ij} = {δ}_{i 5} {δ}_{j 5} / {Z}_{0} \qquad ( 22 )$$

$$K = ( \begin{matrix}{K}_{0} & - {K}_{0} & 0 & 0 & 0 \\ - {K}_{0} & {K}_{0} & 0 & 0 & 0 \\ 0 & 0 & {K}_{1} & - {K}_{1} & 0 \\ 0 & 0 & - {K}_{1} & {K}_{1} & 0 \\ 0 & 0 & 0 & 0 & 0\end{matrix} ) \qquad ( 23 )$$

$${P}^{T} = ( \begin{matrix}0 & 0 & 1 & - 1 & 0\end{matrix} ) \qquad ( 24 )$$

where the port matrix P is defined to isolate the flux across the tunable-frequency qubit device 1004 and C_{iΣ}=Cᵢ+Cᵢₛ+C₀₁+Cᵢₑ. The effective admittance Y_{eff} seen by a reduced circuit for ports given in P can be computed via

$${Y}_{e f f} ( s ) = {[ {{P}^{T} ( \frac{K}{s} + G + C s )}^{- 1} P ]}^{- 1} = \frac{{K}_{e f f}}{s} + {C}_{eff} s + {Y}_{e n v} ( s ) \qquad ( 25 )$$

where C_{eff} and K_{eff} are the effective capacitance and inverse inductance seen by the ports, Yₑₙᵥ is the environmental admittance, and s the independent variable of a Laplace transform.

The resonance condition of the tunable-frequency qubit device is given by Y_{eff}(s)=0. Taking the form

$$s = i ω - \frac{γ}{2} ,$$

where ω is the frequency and γ the decay rate of the mode.

Assume ω=\sqrt{κ_{eff}/C_{eff}} and expand to first order in γ, giving the expression

$$γ \approx \frac{Re [ {Y}_{e n v} ( i ω ) ]}{{C}_{e f f}} . \qquad ( 26 )$$

For each of the tunable-frequency coupler device 1002 and the tunable-frequency qubit device 1004, the effective conductance (K_{i,eff}) and effective capacitance (C_{i,eff}) can be expressed as

$${K}_{i , eff} = {K}_{i} , i = 0 , 1 \qquad ( 27 )$$

$${C}_{i , eff} = {C}_{i} + {C}_{i g} - \frac{{C}_{i g}^{2} {C}_{i \sum }}{{C}_{0 \sum } {C}_{1 \sum } - {C}_{01}^{2}} , i = 0 , 1 .$$

It is found that Re[Yₑₙᵥ(iω₁)] vanishes for the condition

$${ω}_{0} = {ω}_{1} \sqrt{1 + \frac{{C}_{0 g}^{2} {C}_{01} ( {C}_{1 \sum } {C}_{0 e} + {C}_{01} {C}_{1 e} )}{{C}_{0 , eff} ( {C}_{0 \sum } {C}_{1 e} + {C}_{0 e} {C}_{01} ) ( {C}_{0 \sum } {C}_{1 \sum } - {C}_{01}^{2} )}} \qquad ( 28 )$$

where ω₀ is the transition frequency of the tunable-frequency coupler device 1002; and ω₁ is transition frequency of the tunable-frequency qubit device 1004. This vanishing condition can only occur for ω₀>ω₁. The maximum ω₀ occurs if C₁ₑ=0, where

$${ω}_{0} = {ω}_{1} \sqrt{1 + \frac{{C}_{0 g}^{2} {C}_{1 \sum }}{{C}_{0 , eff} ( {C}_{0 \sum } {C}_{1 \sum } - {C}_{01}^{2} )}} \qquad ( 29 )$$

Increasing C₁ₑ pushes the minimum down towards ω₁. Please note that if the tunable-frequency coupler device 1002 and the tunable-frequency qubit device 1004 get too close to resonance we experience an avoided crossing, and this approximation does not hold well. Unintuitively, there is still vanishing if C₀ₑ=0 and C₁ₑ≠0, still maintaining significant frequency separation between the tunable-frequency coupler device 1002 and the tunable-frequency qubit device 1004.

The general Hamiltonian can be broken into three parts,

$$H = {H}_{s} + {H}_{B} + {H}_{i} \qquad ( 30 )$$

where Hₛ is local Hamiltonian for the system of interest, H_{B} is a bath Hamiltonian that models an external environment, and Hᵢ the interaction between the local and bath Hamiltonian. Assume the bath Hamiltonian is modelled as white noise comprised of a continuous collection of modes (in units of ℏ=1), H_{B} can be expressed as

$${H}_{B} = {\int }_{- ∞}^{∞} d ω ω {b}^{†} ( ω ) b ( ω ) \qquad ( 31 )$$

The bath-system interaction can be described by the Hamiltonian,

$${H}_{i} = i {\int }_{- ∞}^{∞} d ω [ {b}^{†} ( ω ) c - {c}^{†} b ( ω ) ] \qquad ( 32 )$$

where generally c=Σᵢκᵢ(ω)c′ᵢ with c′ᵢ being some system operators with corresponding coupling strengths κᵢ(ω) to the bath modes. This model uses the rotating wave approximation and extends the lower limit of ω to −∞ to admit a mathematically simple white noise formalism. The bath operators obey the canonical commutation relation [b(w), b†(ω′)]=δ(ω−ω′). Thus, the equations of motion for a bath operator and arbitrary system operator a are given by

$$\dot{b} ( ω ) = - i ω b ( ω ) + c \qquad ( 33 )$$

$$\dot{a} = - i [ a , {H}_{s} ] + {\int }_{- ∞}^{∞} d ω \{ {b}^{†} ( ω ) [ a , c ] - [ a , {c}^{†} ] b ( ω ) \}$$

This equation of motion can be reduced to

$$\dot{a} = - i [ a , {H}_{s} ] - [ a , {c}^{†} ] ( \frac{c}{2} + {b}_{i n} ) + [ a , c ] ( \frac{{c}^{†}}{2} + {b}_{i n}^{†} ) \qquad ( 34 )$$

where

$${b}_{i n} = {\int }_{- ∞}^{∞} d ω {e}^{- i ω ( t - {t}_{0} )} {b}_{0} ( ω ) \qquad ( 35 )$$

and t₀ is the initial time with b₀(ω)=b(ω)|ₜ₌ₜ_{₀}. Notably, [bᵢₙ(t), b†ᵢₙ(t′)]=2πδ(t−t′), demonstrating the white noise construction. Assuming a two-body Hamiltonian

$${H}_{s} = \frac{Δ}{2} ( {a}_{1}^{†} {a}_{1} - {a}_{0}^{†} {a}_{0} ) + g ( {a}_{0}^{†} {a}_{1} + {a}_{1}^{†} {a}_{0} ) \qquad ( 36 )$$

where a₀ and a₁ are annihilation operators for two resonances (for our system, this is a simplified model ignoring the nonlinearity of transmons for ease of analytic demonstration), g is the coupling between them, and Δ is the bare frequency separation between them. Both resonances are coupled to the same external feedline, which we will represent by defining.

$$c = \sqrt{{κ}_{0}} {a}_{0} + \sqrt{{κ}_{1}} {a}_{1} \qquad ( 37 )$$

where κ₀ and κ₁ are bare decay rates for their respective modes. The structure of this coupling is essential, as the simultaneous communication of both transmon modes with the bath modes allows for destructive interference. The equations of motion are

$$( \begin{matrix}{\dot{a}}_{0} \\ {a}_{1}\end{matrix} ) = ( \begin{matrix}- \frac{{κ}_{0} - i Δ}{2} & - ig - \frac{\sqrt{{κ}_{0} {κ}_{1}}}{2} \\ - ig - \frac{\sqrt{{κ}_{0} {κ}_{1}}}{2} & - \frac{{κ}_{1} + i Δ}{2}\end{matrix} ) ( \begin{matrix}{a}_{0} \\ {a}_{1}\end{matrix} ) + ( \begin{matrix}\sqrt{{κ}_{0}} \\ \sqrt{{κ}_{1}}\end{matrix} ) {b}_{i n} \qquad ( 38 )$$

The eigenvalues of this time evolution are

$${λ}_{\pm } = - \frac{{κ}_{0} + {κ}_{1}}{4} \pm \sqrt{{( \frac{{κ}_{0} + {κ}_{1}}{4} )}^{2} - \frac{{Δ}^{2}}{4} - {g}^{2} + i \{ \frac{Δ}{4} ( {κ}_{1} - {κ}_{0} ) + g \sqrt{{κ}_{0} {κ}_{1}} \}} \qquad ( 39 )$$

If ever the real part of one of these eigenvalues vanishes, we have a dark mode, e.g., a lossless mode. For the condition

$$Δ = \frac{g ( {κ}_{1} - {κ}_{0} )}{\sqrt{{κ}_{0} {κ}_{1}}} \qquad ( 40 )$$

where Δ is the frequency offset.
A dark mode appears alongside the corresponding bright mode, e.g., a lossy mode:

$${λ}_{D} = - \frac{i g ( {κ}_{0} + {κ}_{1} )}{2 \sqrt{{κ}_{0} {κ}_{1}}} \qquad ( 41 )$$

$${λ}_{B} = - \frac{{κ}_{0} + {κ}_{1}}{2} ( 1 - \frac{ig}{\sqrt{{κ}_{0} {κ}_{1}}} )$$

In some implementations, control operations can be performed on the superconducting quantum processing circuit by providing control signals to the tunable-frequency qubit device 1004 and the tunable-frequency coupler device 1002 via associated control lines. The control lines can deliver the control signals, for example, from an external control system. In some implementations, each of the control lines can be a conductor, an inductor, or another type of circuit component configured to carry a respective current I, which generates a respective magnetic flux ω(t) through the superconducting circuit loops 1015, 1019. For instance, the control line may include an inductor (e.g., a partial loop, a single loop, or multiple loops of a conductor) that has a mutual inductance with the superconducting circuit loop 1015, 1019. In the example shown, the transition frequency of the tunable-frequency qubit device 1004 is tuned by tuning a magnetic flux in the superconducting circuit loop 1019; and the transition frequency of the tunable-frequency coupler device 1002 is tuned by tuning a magnetic flux in the superconducting circuit loop 1015. In some instances, the transition frequencies may be controlled in another manner, for instance, by another type of control signal. In some implementations, the control lines may include an inductance loop or another type of flux bias device that is coupled (e.g., conductively, capacitively, or inductively) to a control port to receive control signals, and to the tunable-frequency qubit device 1004. In certain instances, the control signals transmitted on the control lines may cause the flux bias device to generate and modulate the magnetic flux in the superconducting circuit loop 1015, 1019. The equivalent circuit 1000 in FIG. 10 can be operated to receive a quantum state from or transmit a quantum state to another resonator device in another node by performing operations in the example process 700 in FIG. 7 or in another manner.

FIG. 11 is a circuit diagram showing aspects of an equivalent circuit 1100 of a superconducting quantum processing circuit of a node in a computing network. The example equivalent circuit 1100 represents at least a portion of the superconducting quantum processing circuit 206B of the second node 201B in FIG. 2, the second node 304 in FIG. 3A, or the first node 502 in FIG. 5A. The example equivalent circuit 1100 represented in FIG. 11 includes a tunable-frequency coupler device 1104 and a tunable-frequency qubit device 1102. The tunable-frequency coupler device 1104 and the tunable-frequency qubit device 1102 are capacitively coupled to each other through a Purcell filter 1106. Particularly, the tunable-frequency qubit device 1102 is capacitively coupled to a first end 1132B of the Purcell filter 1106 through a residual capacitor 1108. The tunable-frequency coupler device 1104 is galvanically coupled to a second end 1132B of the Purcell filter 1106. The tunable-frequency coupler device is further galvanically connected to the ground plane. A transmission line 1118 is capacitively coupled to the Purcell filter 1106 at a position 1130 of the Purcell filter 1106 through a residual capacitor 1116.

In the example shown in FIG. 11, each of the tunable-frequency qubit device 1102 and the tunable-frequency coupler device 1104 is implemented as a tunable-frequency transmon qubit device. The tunable-frequency qubit device 1102 includes two Josephson junctions 1122A, 1122B. The Josephson junctions 1122A, 1122B are connected in parallel with each other to form a superconducting circuit loop 1123. A magnetic flux in the superconducting circuit loop 1123 is controlled by delivering a flux bias control signal via a first flux bias control line to a flux bias device 1112. The tunable-frequency qubit device 1102 also includes a shunt capacitor 1124, which is connected in parallel with the two Josephson junctions 1122A, 1122B. The shunt capacitor 1124 is caused by two electrodes of the tunable-frequency coupler device 1102. In the example shown in FIG. 11, the tunable-frequency qubit device 1102 is capacitively coupled to the ground plane (e.g., Φ=0) through residual capacitors 1110A, 1110B. In the example shown in FIG. 11, the tunable-frequency qubit device 1102 is floating. In some instances, the tunable-frequency qubit device 1102 may be grounded, in which situation, one of the coupler electrodes can be galvanically connected to the ground plane. In some instances, the equivalent circuit 1100 may include other quantum circuit devices connected by other superconducting lines.

As shown in FIG. 11, the tunable-frequency coupler device 1104 includes two Josephson junctions 1126A, 1126B. The Josephson junctions 1126A, 1126B are connected in parallel with each other to form a superconducting circuit loop 1127. A magnetic flux in the superconducting circuit loop 1127 is controlled by delivering a flux bias control signal via a second flux bias control line to a flux bias device 1114 associated with the superconducting circuit loop 1127.

In some implementations, the Purcell filter 1106 is a half-wave intrinsic Purcell filter, which includes one or more coupled linear resonators. The Purcell filter 1106 allows for rapid collection of the incoming microwave photons during a quantum state transfer process with a maximized transfer efficiency. One example Purcell filter is described in the publication entitled “Fast readout and reset of a superconducting qubit coupled to a resonator with an intrinsic Purcell filter” by Sunada et al., (arXiv: 2202.06202v2 [quantu-ph] Apr. 9, 2022).

By tuning the position 1130 where the transmission line 1118 is coupled on the Purcell filter 1106, microwave flux at the position 1130 of the Purcell filter 1106 and thus the coupling between the tunable-frequency qubit device 1102 and the transmission line 1118 can be tuned. The qubit mode can be visualized as partially hybridized inside the Purcell filter 1106. When the microwave flux vanishes or is below a threshold value at the position 1130 then the transmission line 1118 and the tunable-frequency qubit device 1102 is effectively uncoupled. When a Purcell filter 1106 with an open boundary condition (e.g., when no tunable-frequency coupler device 1104 is coupled to the second end 1132B of the Purcell filter 1106) is used, the vanishing microwave flux occurs at the a position that is a quarter of the qubit wavelength, λ_{q}≡f_{q}/v away from the second end 1132B of the Purcell filter, where v is the propagation speed in the coplanar waveguide. When a tunable-frequency coupler device 1104 is coupled to the Purcell filter 1106 at the second end 1132B, boundary conditions of the Purcell filter 1106 can be modified. The microwave flux at the position 1130 of the Purcell filter 1106 and thus, the effective coupling between the tunable-frequency qubit device 1102 the transmission line 1118 can be modified.

During operation, the coupling between the tunable-frequency qubit device 1102 and the transmission line 1118 is controlled by modifying the magnetic flux applied to the superconducting circuit loop 1127 of the tunable-frequency coupler device 1104. Modifying the magnetic flux applied to the superconducting circuit loop 1127 tunes an effective inductance at the second end 1132B.

In some implementations, the tunable-frequency coupler device 1104 can be operated to tune the effective coupling between the tunable-frequency qubit device 1102 and the transmission line 1118 to a maximum value for maximized transfer efficiency when a quantum state is transferred. In some implementations, the tunable-frequency coupler device 1104 can be operated to tune the effective coupling to a minimum value to protect the quantum state store in the tunable-frequency qubit device 1102. In some implementations, the tunable-frequency coupler device 1104 may be also used as a readout resonator device for readout quantum states in the tunable-frequency qubit device 1102. In this case, only one single control line is required for tunning the coupling and for reading out quantum state.

When a boundary condition at the second end 1132B of the Purcell filter 1106 is changed from “open” to “short” by varying a magnetic flux in the superconducting circuit loop 1127 of the tunable-frequency coupler device 1104, a microwave flux of the qubit mode populating the Purcell filter 1106 shifts accordingly. The microwave flux in the Purcell filter 1106 at the position 1130 and thus, the effective coupling between the tunable-frequency qubit device 1102 and the transmission line 1118 can be modified. In this case, the effective linewidth of the tunable-frequency qubit device 1102 can be modified over time while a signal transferring a quantum state is received at the transmission line 1118. In some implementations, the magnetic flux applied to the superconducting circuit loop 1127 can be determined according to a desired time profile of the effective linewidth of the tunable-frequency qubit device 1102.

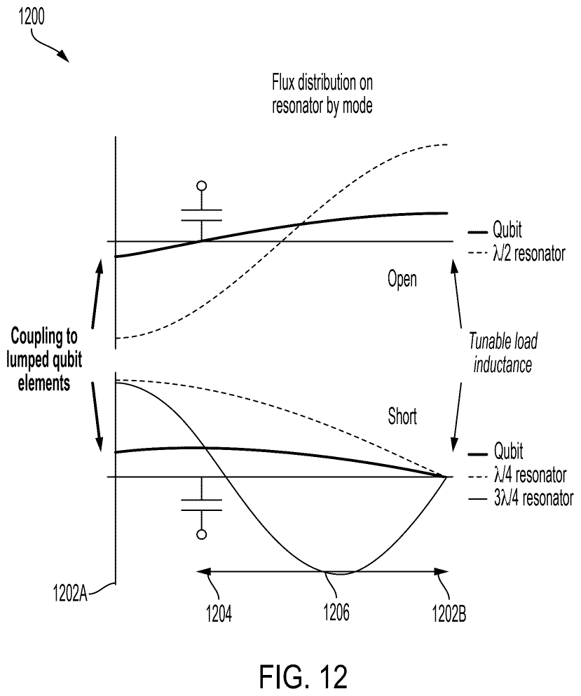

FIG. 12 is a plot 1200 showing distribution of microwave flux along an example Purcell filter in a superconducting quantum processing circuit of a node in a computing network at different boundary conditions. The example Purcell filter can be implemented as the Purcell filter 1106 in the example equivalent circuit 1100 of FIG. 11. The Purcell filter is coupled to a tunable-frequency qubit device at a first end 1202A, and a tunable-frequency coupler device at a second end 1202B. A distance 1206 between a position 1204 where a transmission line is coupled at the Purcell filter and the second end 1202B is fixed.

In a general aspect, transferring a quantum state between nodes in a computing network is disclosed.

In a first example, a method of transferring a quantum state between nodes in a computing network includes, at a first node in the computing network, receiving a signal transmitted on a transmission line from a second node in the computing network. The first node includes a superconducting quantum processing circuit, and the superconducting quantum processing circuit includes a tunable-frequency coupler device with a superconducting circuit loop and a first resonator device having a tunable linewidth capacitively coupled to the tunable-frequency coupler device. The tunable-frequency coupler device is communicably coupled to the transmission line. The second node includes a second resonator device having a fixed linewidth communicably coupled to the transmission line. The method includes modifying the tunable linewidth of the first resonator device over time while the signal transfers a quantum state to the first resonator device from the second resonator device. The tunable linewidth is modified by varying a magnetic flux pulse to the superconducting circuit loop of the tunable-frequency coupler device.

Implementations of the first example may include one or more of the following features. The superconducting quantum processing circuit resides in a controlled environment, and the transmission line is external to the controlled environment. Applying the magnetic flux pulse to the superconducting circuit loop includes by operation of a control system associated with the superconducting quantum processing circuit, generating the flux bias control signal according to pulse parameters of the magnetic flux pulse, and delivering the flux bias control signal to a flux bias control line associated with the tunable-frequency coupler device. The method further includes selecting the pulse parameters to maximize efficiency of transferring the quantum state from the second node to the resonator device. The pulse parameters correspond to a shape of the magnetic flux pulse, an amplitude of the magnetic flux pulse, and a duration of the magnetic flux pulse.

Implementations of the first example may include one or more of the following features. The resonator device includes a qubit device. The resonator device includes a storage device. Modifying the tunable linewidth includes holding the tunable linewidth at a constant value for an initial time period; and reducing the tunable linewidth at an exponential rate over a subsequent time period. The superconducting quantum processing circuit further includes a buffer resonator device capacitively coupled between the transmission line and the tunable-frequency coupler device.

Implementations of the first example may include one or more of the following features. The transmission line includes a superconducting channel. The second resonator device includes a superconducting circuit device. The transmission line includes an optical channel. The second node includes an optical device. The method includes generating the signal at the second node, and transferring the signal from the second node to the first node via the transmission line. The superconducting quantum processing circuit further includes a readout resonator device capacitively coupled to the first resonator device, and the method includes reading out the quantum state received on the second resonator device via the readout resonator device.

Implementations of the first example may include one or more of the following features. The superconducting quantum processing circuit includes a Purcell filter. The first resonator device is capacitively coupled to a first end of the Purcell filter; and the tunable-frequency coupler device is galvanically coupled to a second end of the Purcell filter. The transmission line is capacitively coupled to the Purcell filter at a coupler position residing between the first and second ends of the Purcell filter.

In a second example, a computing network includes a transmission line, a first node communicably coupled to the transmission line, a second node communicably coupled to the transmission line, and a control system. The first node includes a superconducting quantum processing circuit which includes a tunable-frequency coupler device and a first resonator device having a tunable linewidth capacitively coupled to the tunable-frequency coupler device. The a tunable-frequency coupler device includes a circuit loop; and the tunable-frequency coupler device is communicably coupled to the transmission line. The control system is configured to cause the first node to receive a signal transmitted on the transmission line from the second node; and modify the tunable linewidth of the first resonator device over time while the signal transfers a quantum state to the first resonator device from the second resonator device. The tunable linewidth is modified by varying a magnetic flux pulse applied to the circuit loop of the tunable-frequency coupler device.

Implementations of the second example may include one or more of the following features. The superconducting quantum processing circuit resides in a controlled environment, and the transmission line is external to the controlled environment. The control system is associated with the superconducting quantum processing circuit and configured to generate a flux bias control signal according to pulse parameters of the magnetic flux pulse; and deliver the flux bias control signal to a flux bias control line associated with the tunable-frequency coupler device. The control system is configured to select the pulse parameters to maximize efficiency of transferring the quantum state from the second node to the resonator device. The pulse parameters correspond to a shape of the magnetic flux pulse; an amplitude of the magnetic flux pulse; and a duration of the magnetic flux pulse.

Implementations of the second example may include one or more of the following features. The second resonator device includes a qubit device. The second resonator device includes a storage device. The second resonator device includes a superconducting circuit device. The second resonator device includes an optical device. The transmission line includes a superconducting channel. The transmission line includes an optical channel.

Implementations of the second example may include one or more of the following features. The superconducting quantum processing circuit further includes a buffer resonator device capacitively coupled between the transmission line and the tunable-frequency coupler device. The superconducting quantum processing circuit further includes a readout resonator device capacitively coupled to the first resonator device, and the control system is configured to read out the quantum state received on the first resonator device via the readout resonator device. The superconducting quantum processing circuit includes a Purcell filter. The first resonator device is capacitively coupled to a first end of the Purcell filter. The tunable-frequency coupler device is galvanically coupled to a second end of the Purcell filter. The transmission line is capacitively coupled to the Purcell filter at a coupler position residing between the first and second ends of the Purcell filter.

In a third example, a method of transferring a quantum state between nodes in a computing network includes at a first node in the computing network, receiving a signal transmitted on a transmission line from a second node in the computing network. The first node includes a first resonator device having a fixed linewidth communicably coupled to the transmission line. The second node includes a superconducting quantum processing circuit, and the superconducting quantum processing circuit includes a tunable-frequency coupler device with a superconducting circuit loop, and a second resonator device having a tunable linewidth capacitively coupled to the tunable-frequency coupler device. The tunable-frequency coupler device is communicably coupled to the transmission line. The method further includes modifying the tunable linewidth of the second resonator device over time while the signal transfers a quantum state to the first resonator device from the second resonator device. The tunable linewidth is modified by varying a magnetic flux pulse applied to the superconducting circuit loop of the tunable-frequency coupler device.

Implementations of the third example may include one or more of the following features. Modifying the tunable linewidth includes increasing the tunable linewidth at an exponential rate to a constant value over an initial time period; and holding the tunable linewidth at the constant value for a subsequent time period. The superconducting quantum processing circuit resides in a controlled environment, and the transmission line is external to the controlled environment. The first resonator device includes a qubit device. The first resonator device includes a storage device. The first resonator device includes a superconducting circuit device. The first resonator device includes an optical device.

Implementations of the third example may include one or more of the following features. The transmission line includes a superconducting channel. The transmission line includes an optical channel. The superconducting quantum processing circuit further includes a buffer resonator device capacitively coupled between the transmission line and the tunable-frequency coupler device. The superconducting quantum processing circuit includes a Purcell filter, the second resonator device is capacitively coupled to a first end of the Purcell filter. The tunable-frequency coupler device is galvanically coupled to a second end of the Purcell filter. The transmission line is capacitively coupled to the Purcell filter at a coupler position residing between the first and second ends of the Purcell filter.

In a fourth example, a computing network includes a transmission line, a first node including a first resonator device having a fixed linewidth communicably coupled to the transmission line, a second node communicably coupled to the transmission line, and a control system. The second node includes a superconducting quantum processing circuit, which includes a tunable-frequency coupler device communicably coupled to the transmission line, and a second resonator device having a tunable linewidth capacitively coupled to the tunable-frequency coupler device. The tunable-frequency coupler device includes a circuit loop. The control system is configured to cause the first node to receive a signal transmitted on transmission line from the second node; and modify the tunable linewidth of the second resonator device over time while the signal transfers a quantum state to the first resonator device from the second resonator device, wherein the tunable linewidth is modified by varying a magnetic flux pulse applied to the circuit loop of the tunable-frequency coupler device.

Implementations of the fourth example may include one or more of the following features. The superconducting quantum processing circuit resides in a controlled environment, and the transmission line is external to the controlled environment. The superconducting quantum processing circuit further includes a buffer resonator device capacitively coupled between the transmission line and the tunable-frequency coupler device. The superconducting quantum processing circuit includes a Purcell filter. The second resonator device is capacitively coupled to a first end of the Purcell filter. The tunable-frequency coupler device is galvanically coupled to a second end of the Purcell filter. The transmission line is capacitively coupled to the Purcell filter at a coupler position residing between the first and second ends of the Purcell filter.

Implementations of the fourth example may include one or more of the following features. The first resonator device includes a qubit device. the first resonator device includes a storage device. The first resonator device includes a superconducting circuit device. The first resonator device includes an optical device. The transmission line includes a superconducting channel. The transmission line includes an optical channel.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made.

1. A method of transferring a quantum state between nodes in a computing network, the method comprising:
at a first node in the computing network, receiving a signal transmitted on a transmission line from a second node in the computing network, wherein the first node comprises a superconducting quantum processing circuit, and the superconducting quantum processing circuit comprises:
a tunable-frequency coupler device comprising a circuit loop, wherein the tunable-frequency coupler device is communicably coupled to the transmission line; and
a first resonator device having a tunable linewidth capacitively coupled to the tunable-frequency coupler device,
wherein the second node comprises a second resonator device having a fixed linewidth communicably coupled to the transmission line; and
modifying the tunable linewidth of the first resonator device over time while the signal transfers a quantum state to the first resonator device from the second resonator device, wherein the tunable linewidth is modified by varying a magnetic flux pulse applied to the circuit loop of the tunable-frequency coupler device.

2. The method of claim 1, wherein modifying the tunable linewidth comprises:
holding the linewidth at a constant value for an initial time period; and
reducing the linewidth at an exponential rate over a subsequent time period.

3. The method of claim 1, comprising:
generating the signal at the second node; and
transferring the signal from the second node to the first node via the transmission line.

4. The method of claim 1, wherein the superconducting quantum processing circuit resides in a controlled environment, and the transmission line is external to the controlled environment.

5. The method of claim 1, wherein varying the magnetic flux pulse applied to the circuit loop comprises, by operation of a control system associated with the superconducting quantum processing circuit:
generating a flux bias control signal according to pulse parameters of the magnetic flux pulse; and
delivering the flux bias control signal to a flux bias control line associated with the tunable-frequency coupler device.

6. The method of claim 5, comprising:
selecting the pulse parameters to maximize efficiency of transferring the quantum state from the second node to the first resonator device.

7. The method of claim 5, wherein the pulse parameters correspond to:
a shape of the magnetic flux pulse;
an amplitude of the magnetic flux pulse; and
a duration of the magnetic flux pulse.

8. The method of claim 1, wherein the second resonator device comprises a qubit device.

9. The method of claim 1, wherein the second resonator device comprises a storage device.

10. The method of claim 1, wherein the second resonator device comprises a superconducting circuit device.

11. The method of claim 1, wherein the second resonator device comprises an optical device.

12. The method of claim 1, wherein the transmission line comprises a superconducting channel.

13. The method of claim 1, wherein the transmission line comprises an optical channel.

14. The method of claim 1, wherein the superconducting quantum processing circuit further comprises a buffer resonator device capacitively coupled between the transmission line and the tunable-frequency coupler device.

15. The method of claim 1, wherein the superconducting quantum processing circuit further comprises a readout resonator device capacitively coupled to the first resonator device, and the method comprises:
reading out the quantum state received on the first resonator device via the readout resonator device.

16. The method of claim 1, wherein the superconducting quantum processing circuit comprises a Purcell filter, the first resonator device is capacitively coupled to a first end of the Purcell filter, the tunable-frequency coupler device is galvanically coupled to a second end of the Purcell filter, the transmission line is capacitively coupled to the Purcell filter at a coupler position residing between the first and second ends of the Purcell filter.

17. A computing network comprising:
a transmission line;
a first node comprising a superconducting quantum processing circuit, the superconducting quantum processing circuit comprising:
a tunable-frequency coupler device comprising a circuit loop, wherein the tunable-frequency coupler device is communicably coupled to the transmission line; and
a first resonator device having a tunable linewidth capacitively coupled to the tunable-frequency coupler device;
a second node comprising a second resonator device having a fixed linewidth communicably coupled to the transmission line; and
a control system configured to
cause the first node to receive a signal transmitted on the transmission line from the second node; and
modify the tunable linewidth of the first resonator device over time while the signal transfers a quantum state to the first resonator device from the second resonator device, wherein the tunable linewidth is modified by varying a magnetic flux pulse applied to the circuit loop of the tunable-frequency coupler device.

18. The computing network of claim 17, wherein the superconducting quantum processing circuit resides in a controlled environment, and the transmission line is external to the controlled environment.

19. The computing network of claim 17, wherein the control system is associated with the superconducting quantum processing circuit and configured to:
generate a flux bias control signal according to pulse parameters of the magnetic flux pulse; and
deliver the flux bias control signal to a flux bias control line associated with the tunable-frequency coupler device.

20. The computing network of claim 19, wherein the control system is configured to:
select the pulse parameters to maximize efficiency of transferring the quantum state from the second node to the resonator device.

21-51. (canceled)
